(19) United States
(12) Patent Application Publication
(10) Pub. No.: US 2013/0107940 A1
(43) Pub. Date: May 2, 2013

(54) IMAGE PROCESSING DEVICE AND METHOD

(71) Applicant: Kazushi Sato, Kanagawa (JP)

(72) Inventor: Kazushi Sato, Kanagawa (JP)

(73) Assignee: Sony Corporation, Tokyo (JP)

(21) Appl. No.: 13/808,033

(22) PCT Filed: Jul. 1, 2011
(86) PCT No.: PCT/JP11/65210

§ 371 Date: Jan. 2, 2013

(30) Foreign Application Priority Data
Jul. 9, 2010 (JP) 2010-156707

(51) Int. Cl. H04N 7/26

(52) U.S. Cl. CPC H04N 19/00109
USPC 375/240.02

(57) ABSTRACT

The present disclosure relates to an image processing apparatus and method which can improve a coding efficiency. The present technology includes: a scan order control unit which controls a scan order for transforming coefficient data transformed from an image to be coded from a two-dimensional array into a one-dimensional array, according to a statistical value indicating a feature of the image; a scan unit which scans the coefficient data in the two-dimensional array according to the scan order controlled by the scan order control unit, and rearranges the coefficient data in the one-dimensional array; and a coding unit which codes the coefficient data rearranged in the one-dimensional array by the scan unit. The present technology is applicable to, for example, an image processing apparatus.

### TECHNICAL FIELD

The present disclosure relates to an image processing apparatus and method and, more particularly, relates to an image processing apparatus and method which can improve a coding efficiency.

### BACKGROUND ART

Recently, apparatuses which are based on a scheme such as MPEG (Moving Picture Experts Group) for performing compression by orthogonal transform such as discrete cosine transform and motion compensation using redundancy unique to image information to digitally process image information and then efficiently transmit and accumulate information are spreading to distribute information from, for example, broadcast stations and receive information at standard home.

Particularly, MPEG 2 (ISO (International Organization for Standardization)/IEC (International Electrotechnical Commission) 13818-2) is defined as a general-purpose image coding scheme, and is currently widely used in a wide range of applications for professional use and consumer use according to a standard which covers both of interlace scan images and non-interlace images, and standard resolution images and high definition images. By using the MPEG 2 compression scheme and allocating the amount of code (bit rate) such as 4 to 8 Mbps for an interlace scan image of standard resolution having 720×480 pixels and 18 to 22 Mbps for an interlace scan image having 1920×1088 pixels, it is possible to provide a high compression rate and good image quality.

Although MPEG 2 targets at high image quality adapted mainly for broadcasting, MPEG 2 does not support a coding scheme of a lower amount of code (bit rate) than MPEG 1, that is, a higher compression rate. As mobile terminals spread, needs for such a coding scheme is expected to increase in the future, and a MPEG 4 coding scheme is standardized following this increase. As to an image coding scheme, specifications thereof were approved as an international standard as ISO/IEC 14496-2 in December, 1998.

Further, in recent years, a specification of H.26L (ITU-T (International Telecommunication Union Telecommunication Standardization Sector) Q6/16 VCEG (Video Coding Expert Group)) is originally being standardized to code images for television conferences. H.26L requires a more computation amount for coding and decoding than conventional coding schemes such as MPEG 2 and MPEG 4, and is known to provide a higher coding efficiency. Further, Joint Model of Enhanced-Compression Video Coding for providing a higher coding efficiency by taking in functions which are not supported by H.26L, is currently standardized based on this H.26L as a part of an activity of MPEG 4.

According to a standardization schedule, Joint Model of Enhanced-Compression Video Coding became the international standard in the name of H.264 and MPEG-4 Part 10 (Advanced Video Coding and, hereinafter, “AVC”) in March, 2003.

Further, standardization of FRExt (Fidelity Range Extension) including coding tools required for business use such as RGB, and 4:2:2 and 4:4:4, and also including 8×8 DCT and a quantization matrix defined according to MPEG-2 was completed in February, 2005 as an extension of Joint Model of Enhanced-Compression Video Coding, and became a coding scheme which can well express even film noise included in movies using AVC and was used for a wide variety of applications such as Blu-Ray Disc.

However, in recent years, needs for coding at a higher compression rate such as needs to compress an image of about 4000×2000 pixels which is four times as a hi-vision image or to distribute a hi-vision image in environment of limited transmission capacity such as Internet are increasing. Hence, above-described VCEG which is the division of ITU-T continuously studies improvement of a coding efficiency.

For example, adopting 16 pixels×16 pixels for a macroblock size which is a partial area which is an orthogonal transform processing unit of an image as in a conventional technique is not optimal for a large image frame such as UHD (Ultra High Definition; 4000 pixels×2000 pixels) which is a target of the next-generation coding scheme. For example, Non-Patent Document 1 makes a proposal to increase a macroblock size to a size such as 64×64 pixels or 32×32 pixels.

That is, according to Non-Patent Document 1, by adopting a layered structure, a larger block is defined as a superset while keeping for a 16×16 pixel block or less compatibility with a macroblock in current AVC.

While Non-Patent Document 1 makes a proposal to apply an extended macroblock to an interslice, Non-Patent Document 2 makes a proposal to apply an extended macroblock to an intraslice.

Meanwhile, 4×4 orthogonal transform and 8×8 orthogonal transform scan schemes defined in AVC are fixed irrespectively of sequences and bit rates.

### CITATION LIST

### Non-Patent Documents

Non-Patent Document 1: Peisong Chenn, Yan Ye, Marta Karczewicz, “Video Coding Using Extended Block Sizes”, COM16-C123-E, Qualcomm Inc, January 2009
Non-Patent Document 2: Sung-Chang Lim, Hahyun Lee, Jinho Lee, Jongho Kim, Haechul Choi, Seyoon Jeong, Jin Soo Choi, “Intra coding using extended block size”, VCEG-AL28, July 2009

### SUMMARY OF THE INVENTION

### Problems to be Solved by the Invention

However, a distribution of non-zero coefficients depends on an image, and therefore a scan scheme which is prepared in advance is not optimal at all times and there is a concern that it is not possible to sufficiently improve a coding efficiency.

Particularly, in case of the above extended macroblock, an area size is large, and non-zero coefficients are biased in more various ways. Therefore, it is much less likely that the scan scheme prepared in advance is optimal, and the likelihood that a chance to further improve a coding efficiency is left increases (the likelihood that it is possible to sufficiently improve a coding efficiency decreases).

The present disclosure is made in light of this situation, and an object of the present invention is to improve a coding efficiency by adaptively determining a scan order according to an image.

### Solutions to Problems

According to an aspect of the present disclosure, an image processing apparatus has: a scan order control unit which controls a scan order for transforming coefficient data transformed from an image to be coded from a two-dimensional array into a one-dimensional array, according to a statistical value indicating a feature of the image; a scan unit which scans the coefficient data in the two-dimensional array according to the scan order controlled by the scan order control unit, and rearranges the coefficient data in the one-dimensional array; and a coding unit which codes the coefficient data rearranged in the one-dimensional array by the scan unit.

The scan order control unit has: a calculation unit which calculates an appearance frequency of a non-zero coefficient of the coefficient data per pixel position in a partial area of the image which is a processing unit of transform processing of transforming the image and generating the coefficient data and in a predetermined data unit; and an update unit which updates the scan order in order of the appearance frequency of the non-zero coefficient of each pixel position in the partial area calculated by the calculation unit, and the scan unit can scan the coefficient data according to the scan order updated by the update unit.

The scan order control unit further has a determination unit which determines as the scan order one of an initial order which is a predetermined scan order set in advance and an update order which is the scan order updated by the update unit, and the scan unit can scan the coefficient data according to the scan order determined by the determination unit from the initial order and the update order.

The scan order control unit further has a decision unit which decides whether or not a processing target is an IDR picture, and the determination unit can determine the initial order as the scan order when the decision unit decides that the processing target is the IDR picture, and determine the update order as the scan order when the decision unit decides that the processing target is not the IDR picture.

The scan order control unit further has a detection unit which detects a scene change, and the determination unit can determine the initial order as the scan order when the detection unit detects the scene change in the processing target, and determine the update order as the scan order when the detection unit does not detect the scene change in the processing target.

The scan order control unit further has a generation unit which generates flag information indicating whether the determination unit determines the initial order as the scan order or selects the update order, and the coding unit can further code the flag information generated by the generation unit.

The update unit can update the scan order to an order matching an order of the appearance frequency of the non-zero coefficient of each pixel position in the partial area of an image coded in a past.

When a single picture is divided into a plurality of slices and processed, the update unit can update the scan order according to the order of the appearance frequency of the non-zero coefficient of each pixel position in the partial area of a slice coded immediately before.

When a single picture is divided into a plurality of slices and processed, the update unit can update the scan order according to an order of the appearance frequency of the non-zero coefficient of each pixel position in the partial area of a slice at a same position as a current slice of a picture coded immediately before.

When a single picture is divided into a plurality of slices and each slice is processed in parallel, the update unit can update the scan order according to an order of the appearance frequency of the non-zero coefficient of each pixel position in the partial area of a slice at a same position as a current slice of a picture coded immediately before.

The update unit can update the scan order to an order matching an order of the appearance frequency of the non-zero coefficient of each pixel position in the partial area of a current image to be coded.

The scan control unit can control the scan order per size of a partial area of the image which is a processing unit of transform processing of transforming the image and generating the coefficient data.

The scan control unit can control the scan order per type of a current image.

Further, according to an aspect of the present disclosure, an image processing method of an image processing apparatus includes: at a scan order control unit, controlling a scan order for transforming coefficient data transformed from an image to be coded from a two-dimensional array into a one-dimensional array, according to a statistical value indicating a feature of the image; at a scan unit, scanning the coefficient data in the two-dimensional array according to the scan order, and rearranging the coefficient data in the one-dimensional array; and at a coding unit, coding the coefficient data rearranged in the one-dimensional array.

According to another aspect of the present disclosure, an image processing apparatus has: a decoding unit which decodes coded data of an image generated by controlling a scan order for transforming coefficient data transformed from the image to be coded from a two-dimensional array into a one-dimensional array according to a statistical value indicating a feature of the image; a reverse scan order control unit which controls a reverse scan order for transforming the coefficient data obtained by decoding the coded data in the decoding unit, from the one-dimensional array into the two-dimensional array according to the statistical value indicating the feature of the image; and a reverse scan unit which reversely scans the coefficient data in the one-dimensional array according to the reverse scan order controlled by the reverse scan order control unit, and rearranges the coefficient data in the two-dimensional array.

The reverse scan order control unit has: a calculation unit which calculates an appearance frequency of a non-zero coefficient of the coefficient data per pixel position in a partial area of the image which is a processing unit of transform processing of transforming the image and generating the coefficient data and in a predetermined data unit; and an update unit which updates the reverse scan order in order of the appearance frequency of the non-zero coefficient of each pixel position in the partial area calculated by the calculation unit, and the reverse scan unit can reversely scan the coefficient data according to the reverse scan order updated by the update unit.

The reverse scan order control unit further has a determination unit which determines as the reverse scan order one of an initial order which is a predetermined reverse scan order set in advance and an update order which is the reverse scan order updated by the update unit, and the reverse scan unit can reversely scan the coefficient data according to the reverse scan order determined by the determination unit from the initial order and the update order.

The reverse scan order control unit further has an IDR decision unit which decides whether or not a processing target is an IDR picture, and the determination unit can determine the initial order as the reverse scan order when the IDR decision unit decides that the processing target is the IDR picture, and determine the update order as the reverse scan order when the decision unit decides that the processing target is not the IDR picture.

The reverse scan order control unit further has a flag decision unit which decides a value of flag information indicating whether a scan order of the coefficient data is the initial order or the update order, and the determination unit can determine the initial order as the reverse scan order when the flag decision unit decides that the scan order of the coefficient data is the initial order, and determine the update order as the reverse scan order when the flag decision unit decides that the scan order of the coefficient data is the update order.

Further, according to another aspect of the present disclosure, an image processing method of an image processing apparatus includes: at a decoding unit, decoding coded data of an image generated by controlling a scan order for transforming coefficient data transformed from the image to be coded from a two-dimensional array into a one-dimensional array according to a statistical value indicating a feature of the image; at a reverse scan order control unit, controlling a reverse scan order for transforming the coefficient data obtained by decoding the coded data, from the one-dimensional array into the two-dimensional array according to the statistical value indicating the feature of the image; and at a reverse scan unit, reversely scanning the coefficient data in the one-dimensional array according to the reverse scan order, and rearranging the coefficient data in the two-dimensional array.

According to one aspect of the present disclosure, a scan order for transforming coefficient data transformed from an image to be coded from a two-dimensional array into a one-dimensional array is controlled according to a statistical value indicating a feature of an image, the coefficient data in the two-dimensional array is scanned according to the scan order and rearranged in the one-dimensional array, and the coefficient data rearranged in the one-dimensional array is coded.

According to another aspect of the present disclosure, coded data of an image generated by controlling a scan order for transforming coefficient data transformed from an image to be coded from a two-dimensional array into a one-dimensional array according to a statistical value indicating a feature of the image is decoded, a reverse scan order for transforming the coefficient data obtained by decoding the coded data from the one-dimensional array into the two-dimensional array is controlled according to the statistical value indicating the feature of the image, and the coefficient data in the one-dimensional array is reversely scanned according to the reverse scan order and rearranged in the two-dimensional array.

### Effects of the Invention

The present disclosure can process images. Particularly, the present invention can improve a coding efficiency.

### BRIEF DESCRIPTION OF DRAWINGS

FIG. 1 is a view for explaining an intra 16×16 coding scheme defined in an AVC coding scheme.

FIG. 2 is a view illustrating zigzag scan and field scan schemes with respect to a 4×4 orthogonal transform block defined in the AVC coding scheme.

FIG. 3 is a view illustrating that 4×4 orthogonal transform and 8×8 orthogonal transform can be adaptively used in a screen for a high profile or more in the AVC coding scheme.

FIG. 4 is a view illustrating zigzag scan and field scan schemes with respect to a 8×8 orthogonal transform block defined in the AVC coding scheme.

FIG. 5 is a view illustrating an example of a macroblock.

FIG. 6 is a block diagram illustrating a main configuration example of an image coding apparatus.

FIG. 7 is a block diagram illustrating a main configuration example of an adaptive scan control unit.

FIG. 8 is a view for explaining an example where a scan order is adaptively determined.

FIG. 9 is a flowchart for explaining an example of a coding processing flow.

FIG. 10 is a flowchart for explaining an example of a lossless coding processing flow.

FIG. 11 is a block diagram illustrating a main configuration example of an image decoding apparatus.

FIG. 12 is a block diagram illustrating a main configuration example of an adaptive scan control unit.

FIG. 13 is a flowchart for explaining an example of a decoding processing flow.

FIG. 14 is a flowchart for explaining an example of a lossless decoding processing flow.

FIG. 15 is a view illustrating a method of updating scanning per slice type.

FIG. 16 is a view illustrating a method of performing processing of dividing a single picture into a plurality of slices.

FIG. 17 is a block diagram illustrating a main configuration example of a personal computer.

FIG. 18 is a block diagram illustrating a main configuration example of a television receiver.

FIG. 19 is a block diagram illustrating a main configuration example of a mobile telephone.

FIG. 20 is a block diagram illustrating a main configuration example of a hard disk recorder.

FIG. 21 is a block diagram illustrating a main configuration example of a camera.

### MODE FOR CARRYING OUT THE INVENTION

Hereinafter, modes (hereinafter, embodiments) for carrying out the present invention will be described. In addition, the embodiments will be described in the following order.

1. First embodiment (image coding apparatus)
2. Second embodiment (image decoding apparatus)
3. Third embodiment (personal computer)
4. Fourth embodiment (television receiver)
5. Fifth embodiment (mobile telephone)
6. Sixth embodiment (hard disk recorder)
7. Seventh embodiment (camera)

### 1. First Embodiment

### [Scan Scheme]

Similar to a conventional coding scheme such as MPEG-2, it is necessary to rearrange quantized orthogonal transform coefficients obtained as a two-dimensional array after orthogonal transform is performed to data in a one-dimensional array for lossless coding.

In a baseline profile, a main profile and an extended profile in AVC, 4×4 pixels are adopted as a unit for orthogonal transform.

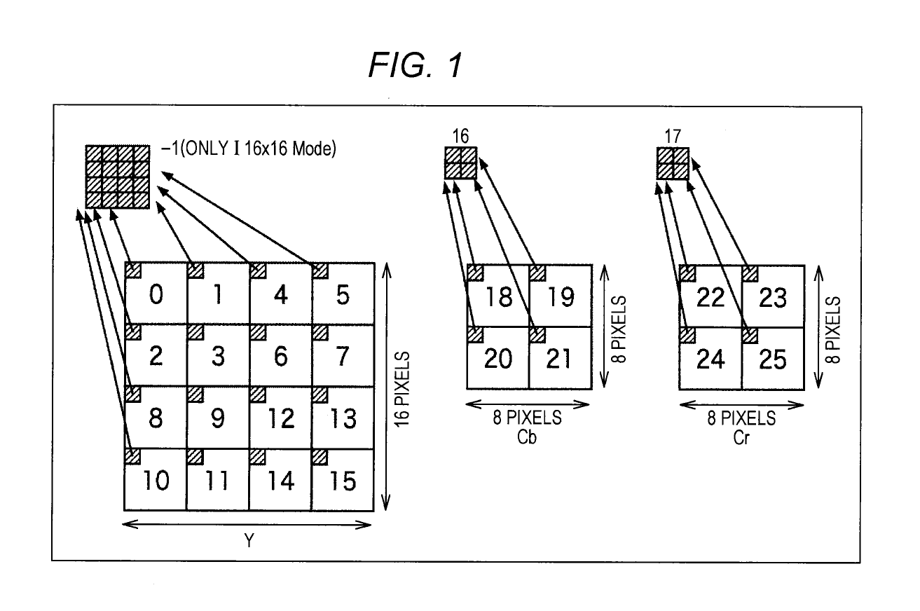

Further, as illustrated in FIG. 1, only in case of an intra 16×16 mode, orthogonal-transformed direct current components of each 4×4 block are collected to obtain a 4×4 matrix and Hadamard-transform this 4×4 matrix.

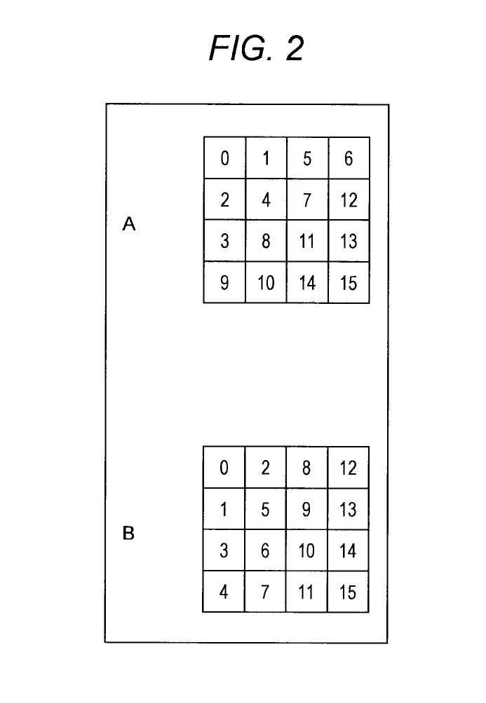

For a method of transforming a 4×4 array into a one-dimensional sixteenth order array, one of zigzag scanning indicated by A in FIG. 2 and field scanning indicated by B in FIG. 2 is used according to whether the block is frame-coded or field-coded.

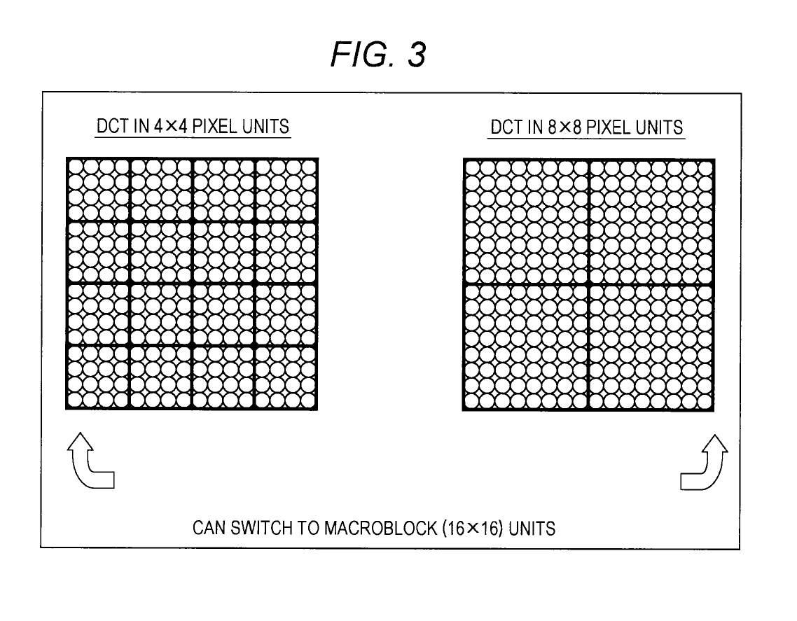

Further, in AVC, in case of a high profile or more, it is possible to adaptively switch between 4×4 orthogonal transform and 8×8 orthogonal transform on a screen as illustrated in FIG. 3 to use.

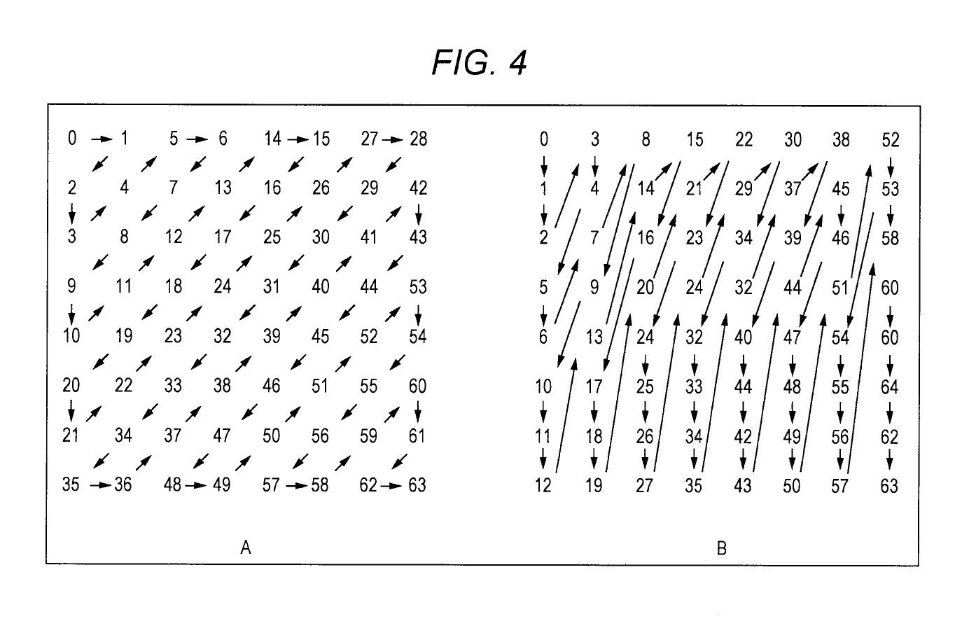

When 8×8 orthogonal transform is used, quantized orthogonal transform coefficients in a two-dimensional array are transformed into a one-dimensional array by using one of zigzag scanning indicated by A in FIG. 4 or field scanning indicated by B in FIG. 4 according to whether the block is frame-coded or field coded.

### [Selection of Prediction Mode]

According to the AVC coding scheme, it is important to select an appropriate prediction mode to achieve a higher coding efficiency.

Such a selection method includes, for example, a method implemented in reference software (released in (http://iphome.hhi.de/suehring/tml/index.htm)) of H.264/MPEG-4 AVC which is referred to as JM (Joint Model).

In JM, following two mode decision methods of High Complexity Mode and Low Complexity Mode can be selected. Both methods are directed to calculating a cost function value related to each prediction mode, and selecting the prediction mode which minimizes the cost function value as an optimal mode with respect to the sub macroblock or the macroblock.

A cost function in High Complexity Mode is expressed as following Equation (1).

Cost(ModeεΩ)=D+λ*R (1)

Meanwhile, Ω is a total set of a candidate mode for coding the block or the macroblock, and D is differential energy between a decoded image and an input image when an image is coded in the prediction mode. λ is a Lagrange undetermined multiplier given as a function of a quantization parameter. R is a total amount of code including orthogonal transform coefficients when coding is performed in the mode.

That is, in order to perform coding in High Complexity Mode, temporary encode processing needs to be performed once in all candidate modes to calculate above parameters D and R, and therefore a higher computation amount is required.

A cost function in Low Complexity Mode is expressed as following Equation (2).

Cost(ModeεΩ)=D+QP2Quant(QP)*HeaderBit (2)

Meanwhile, D is differential energy between a prediction image and an input image unlike High Complexity Mode. QP2Quant (QP) is given as a function of a quantization parameter QP, and HeaderBit is the amount of code which does not include orthogonal transform coefficients and which relates to information such as a motion vector or a mode belonging to Header.

That is, although, in Low Complexity Mode, prediction processing needs to be performed in each candidate mode, a decoded image is not necessary, and even coding processing does not need to be performed. Consequently, it is possible to realize Low Complexity Mode with a lower computation amount than High Complexity Mode.

### [Extended Macroblock]

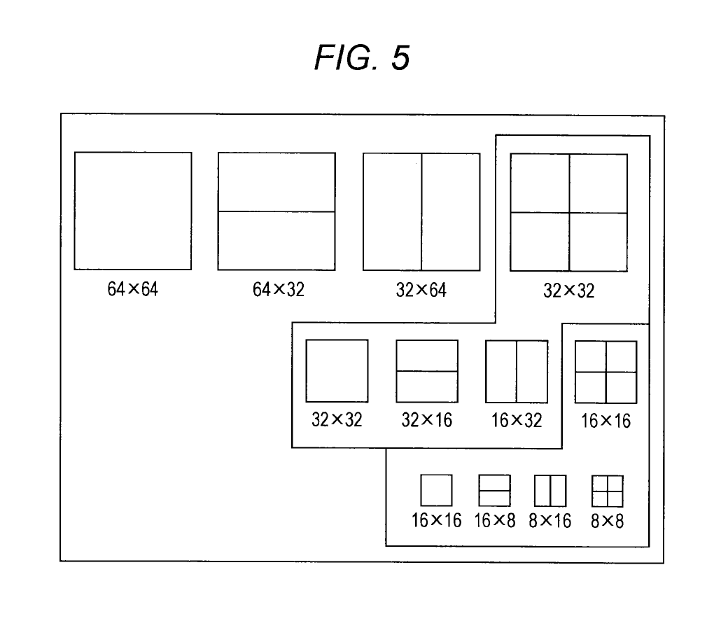

For example, adopting 16 pixels×16 pixels for a macroblock size is not optimal for a large image frame such as UHD (Ultra High Definition; 4000 pixels×2000 pixels) which is a target of the next-generation coding scheme. For example, Non-Patent Document 1 makes a proposal to increase a macroblock size to a size such as 64×64 pixels or 32×32 pixels as illustrated in FIG. 5.

That is, according to Non-Patent Document 1, by adopting a layered structure as illustrated in FIG. 5, a larger block is defined as a superset while keeping for a block of 16×16 pixels or less compatibility with a macroblock in current AVC.

Hereinafter, a macroblock equal to or less than 16×16 pixels is referred to as a “normal macroblock”, and a macroblock larger than 16×16 pixels is referred to as an “extended macroblock”.

While Non-Patent Document 1 makes a proposal to apply an extended macroblock to an interslice, Non-Patent Document 2 makes a proposal to apply an extended macroblock to an intraslice.

According to Non-Patent Document 1 and Non-Patent Document 2, a larger block such as 16×16 which is larger than a block defined in the AVC coding scheme can also be used for an orthogonal transform size.

### [Adaptive Scan Method]

Although scan schemes of 4×4 orthogonal transform and 8×8 orthogonal transform are prepared in advance according to a conventional scheme such as AVC, a distribution (bias) of non-zero coefficients differs depending on images. Hence, scanning is not performed in an optimal scan order at all times. That is, by performing scanning in a scan order which is more suitable for an image quality, it is possible to further improve a coding efficiency.

Particularly, in case of the above extended macroblock, an area size is large, and non-zero coefficients are biased in more various ways. Therefore, it is much less likely that the scan scheme prepared in advance is optimal, and the likelihood that a chance to further improve a coding efficiency is left increases (the likelihood that it is possible to sufficiently improve a coding efficiency decreases).

Hence, the present invention increases a zero-run value and improves a coding efficiency by adaptively determining a scan order according to an image.

### [Image Coding Apparatus]

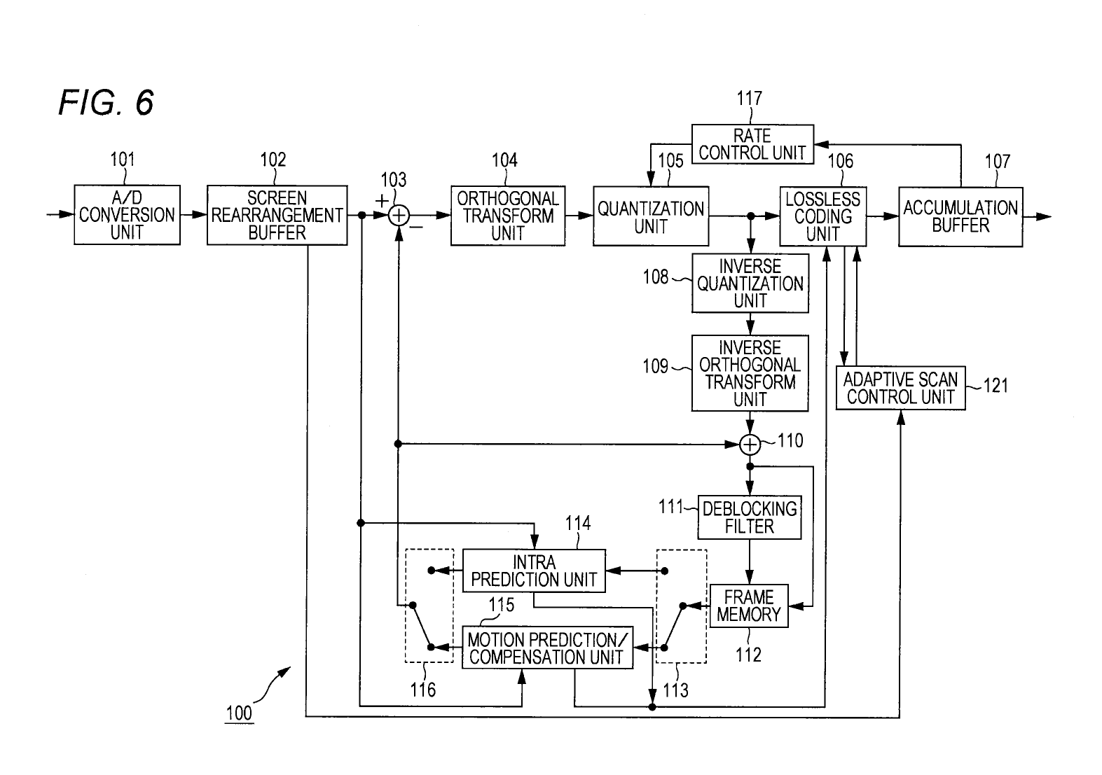

FIG. 6 illustrates a configuration of an embodiment of an image coding apparatus which is an image processing apparatus.

An image coding apparatus 100 illustrated in FIG. 6 is, for example, a coding apparatus which codes images according to the same scheme as a H.264 and MPEG (Moving Picture Experts Group) 4 Part 10 (AVC (Advanced Video Coding)) (hereinafter, referred to as “H.264/AVC”) scheme. Meanwhile, the image coding apparatus 100 adopts a skip mode and a direct mode even for a square block and a rectangular block. By so doing, the image coding apparatus 100 can improve a coding efficiency.

With an example in FIG. 6, the image coding apparatus 100 has an A/D (Analog/Digital) conversion unit 101, a screen rearrangement buffer 102, a computation unit 103, an orthogonal transform unit 104, a quantization unit 105, a lossless coding unit 106 and an accumulation buffer 107. Further, the image coding apparatus 100 has an inverse quantization unit 108, an inverse orthogonal transform unit 109, a computation unit 110, a deblocking filter 111, a frame memory 112, a selection unit 113, an intra prediction unit 114, a motion prediction/compensation unit 115, a selection unit 116 and a rate control unit 117.

The image coding apparatus 100 further has an adaptive scan control unit 121.

The A/D conversion unit 101 A/D converts inputted image data, and outputs and stores the image data to and in the screen rearrangement buffer 102.

The screen rearrangement buffer 102 rearranges a frame image of a stored display order, in a frame order for coding according to a GOP (Group of Picture) structure. The screen rearrangement buffer 102 supplies an image of a rearranged frame order, to the computation unit 103. Further, the screen rearrangement buffer 102 also supplies the image of the rearranged frame order to the intra prediction unit 114 and the motion prediction/compensation unit 115.

The computation unit 103 subtracts a prediction image supplied from the intra prediction unit 114 or the motion prediction/compensation unit 115 through the selection unit 116, from the image read from the screen rearrangement buffer 102, and outputs difference information to the orthogonal transform unit 104.

When, for example, an image is intra-coded, the computation unit 103 subtracts the prediction image supplied from the intra prediction unit 114, from the image read from the screen rearrangement buffer 102. Further, when, for example, an image is inter-coded, the computation unit 103 subtracts the prediction image supplied from the motion prediction/compensation unit 115, from the image read from the screen rearrangement buffer 102.

The orthogonal transform unit 104 applies orthogonal transform such as discrete cosine transform or Karhunen-Loeve transform to the difference information supplied from the computation unit 103, and supplies transform coefficients to the quantization unit 105.

The quantization unit 105 quantizes the transform coefficients outputted from the orthogonal transform unit 104. The quantization unit 105 sets a quantization parameter based on information supplied from the rate control unit 117, and performs quantization. The quantization unit 105 supplies the quantized transform coefficients to the lossless coding unit 106.

The lossless coding unit 106 applies lossless-coding such as variable-length coding or arithmetic coding to the quantized transform coefficients.

The lossless coding unit 106 acquires, for example, information indicating intra prediction, from the intra prediction unit 114, and acquires, for example, information indicating an inter prediction mode and motion vector information, from the motion prediction/compensation unit 115. In addition, the information indicating intra prediction (intra-screen prediction) is also referred to as “intra prediction mode information” below. Further, the information indicating an information mode indicating inter prediction (inter-screen prediction) is also referred to as “inter prediction mode information” below.

The lossless coding unit 106 codes the quantized transform coefficients, and makes (multiplexes) various pieces of information such as a filter coefficient, intra prediction mode information, inter prediction mode information and a quantization parameter as part of header information of coded data. The lossless coding unit 106 supplies and accumulates coded data obtained by coding, to and in the accumulation buffer 107.

For example, the lossless coding unit 106 performs lossless coding processing such as variable-length coding or arithmetic coding. Variable-length coding is, for example, CAVLC (Context-Adaptive Variable Length Coding) defined according to the H.264/AVC scheme. Arithmetic coding is, for example, CABAC (Context-Adaptive Binary Arithmetic Coding).

The accumulation buffer 107 temporarily holds the coded data supplied from the lossless coding unit 106, and outputs, for example, the coded data to a recording apparatus or a channel which is not illustrated at a later stage at a predetermined timing as a coded image coded according to the H.264/AVC scheme.

Further, the transform coefficients quantized by the quantization unit 105 are also supplied to the inverse quantization unit 108. The inverse quantization unit 108 inversely quantizes the quantized transform coefficients according to a method supporting quantization by the quantization unit 105. The inverse quantization unit 108 supplies the resulting transform coefficients to the inverse orthogonal transform unit 109.

The inverse orthogonal transform unit 109 inversely orthogonal-transforms the supplied transform coefficients according to a method supporting orthogonal transform processing by the orthogonal transform unit 104. The inversely orthogonal-transformed output (restored difference information) is supplied to the computation unit 110.

The computation unit 110 adds the prediction image supplied from the intra prediction unit 114 or the motion prediction/compensation unit 115 through the selection unit 116, to the inverse orthogonal transform result supplied from the inverse orthogonal transform unit 109, that is, the restored difference information, and obtains a locally decoded image (decoded image).

When, for example, the difference information matches an intra-coded image, the computation unit 110 adds the prediction image supplied from the intra prediction unit 114 to this difference information. Further, when, for example, the difference information matches an inter-coded image, the computation unit 110 adds the prediction image supplied from the motion prediction/compensation unit 115 to this difference information.

The addition result is supplied to the deblocking filter 111 or the frame memory 112.

The deblocking filter 111 cancels block distortion of a decoded image by adequately performing deblocking filter processing, and improve image quality by adequately performing loop filter processing using, for example, a Wiener filter. The deblocking filter 111 classifies each pixel, and applies adequate filter processing per class. The deblocking filter 111 supplies the filter processing result to the frame memory 112.

The frame memory 112 outputs an accumulated reference image to the intra prediction unit 114 or the motion prediction/compensation unit 115 through the selection unit 113 at a predetermined timing.

When, for example, an image is intra-coded, the frame memory 112 supplies the reference image to the intra prediction unit 114 through the selection unit 113. Further, when, for example, an image is inter-coded, the frame memory 112 supplies the reference image to the motion prediction/compensation unit 115 through the selection unit 113.

When the reference image supplied from the frame memory 112 is an image to be intra-coded, the selection unit 113 supplies the reference image to the intra prediction unit 114. Further, when the reference image supplied from the frame memory 112 is an image to be inter-coded, the selection unit 113 supplies the reference image to the motion prediction/compensation unit 115.

The intra prediction unit 114 performs intra-prediction (intra-screen prediction) of generating a prediction image using a pixel value in a screen. The intra prediction unit 114 performs intra-prediction in a plurality of modes (Intra-prediction modes).

The intra prediction unit 114 generates prediction images in all intra prediction modes, evaluates each prediction image and selects an optimal mode. When selecting the optimal intra prediction mode, the intra prediction unit 114 supplies the prediction image generated in the optimal mode, to the computation unit 103 and the computation unit 110 through the selection unit 116.

Further, as described above, the intra prediction unit 114 adequately supplies information such as intra prediction mode information indicating an adopted intra prediction mode, to the lossless coding unit 106.

The motion prediction/compensation unit 115 performs motion prediction for an image to be inter-coded using the input image supplied from the screen rearrangement buffer 102 and the reference image supplied from the frame memory 112 through the selection unit 113, performs motion compensation processing according to a detected motion vector, and generates a prediction image (inter prediction image information).

The motion prediction/compensation unit 115 performs inter prediction processing in all candidate inter prediction modes, and generates prediction images. The motion prediction/compensation unit 115 calculates a cost function of each mode, and selects an optimal mode.

The motion prediction/compensation unit 115 supplies the prediction image generated in the inter prediction mode selected in this way, to the computation unit 103 and the computation unit 110 through the selection unit 116.

Further, the motion prediction/compensation unit 115 supplies inter prediction mode information indicating the adopted inter prediction mode, and vector information indicating the calculated motion vector, to the lossless coding unit 106.

The selection unit 116 supplies an output of the intra prediction unit 114 to the computation unit 103 and the computation unit 110 in case of an image to be intra-coded, and supplies an output of the motion prediction/compensation unit 115 to the computation unit 103 and the computation unit 110 in case of an image to be inter-coded.

The rate control unit 117 controls a rate of a quantization operation of the quantization unit 105 based on a compressed image accumulated in the accumulation buffer 107 to prevent occurrence of an overflow or an underflow.

The adaptive scan control unit 121 adaptively controls a scan order for transforming the quantized orthogonal transform coefficients in a two-dimensional array in the lossless coding unit 106 into a one-dimensional array, according to an image.

The adaptive scan control unit 121 acquires the quantized orthogonal transform coefficients from the lossless coding unit 106, observes a distribution of non-zero coefficients having values which are non-zero, and determines the scan order of the quantized orthogonal transform coefficients in the lossless coding unit 106 according to the state of the distribution. The adaptive scan control unit 121 determines the scan order using the distribution of non-zero coefficients in the image coded in the past utilizing a high likelihood that images having similar features continue in a movie.

The lossless coding unit 106 scans the quantized orthogonal transform coefficients according to the scan order determined by the adaptive scan control unit 121 according to this control.

The adaptive scan control unit 121 further acquires the input image from the screen rearrangement buffer 102, and decides whether or not a processing target is an IDR (Instantaneous Decoding Refresh) picture. When the processing target is the IDR picture, relevance with a previous image is low and a feature of the image is highly likely to significantly change, and then the adaptive scan control unit 121 determines a predetermined order (initial order) set in advance as a scan order to prevent the coding efficiency from decreasing due to inappropriate use of the scan order.

Further, the adaptive scan control unit 121 detects whether or not a scene change occurs from the input image acquired from the screen rearrangement buffer 102. When the scene change occurs, relevance with a previous image is low and a feature of the image is highly likely to significantly change, and then the adaptive scan control unit 121 determines a predetermined order (initial order) set in advance as a scan order to prevent the coding efficiency from decreasing due to inappropriate use of the scan order.

Further, the adaptive scan control unit 121 generates flag information (default_scan_flag) indicating whether the scan order is set to an update order updated according to an image or to the initial order determined in advance. This flag information is coded together with an image (quantized orthogonal transform coefficients) by the lossless coding unit 106, and is transmitted to a decoding side. The decoding side can learn whether the scan order is the initial order or the update order based on this flag information.

In addition, when a scan order is determined using a distribution of non-zero coefficients in an image coded in the past, the scan order can be updated even on the decoding side, and therefore the scan order does not need to be transmitted. That is, the image coding apparatus 100 improves the coding efficiency accordingly.

### [Adaptive Scan Control Unit]

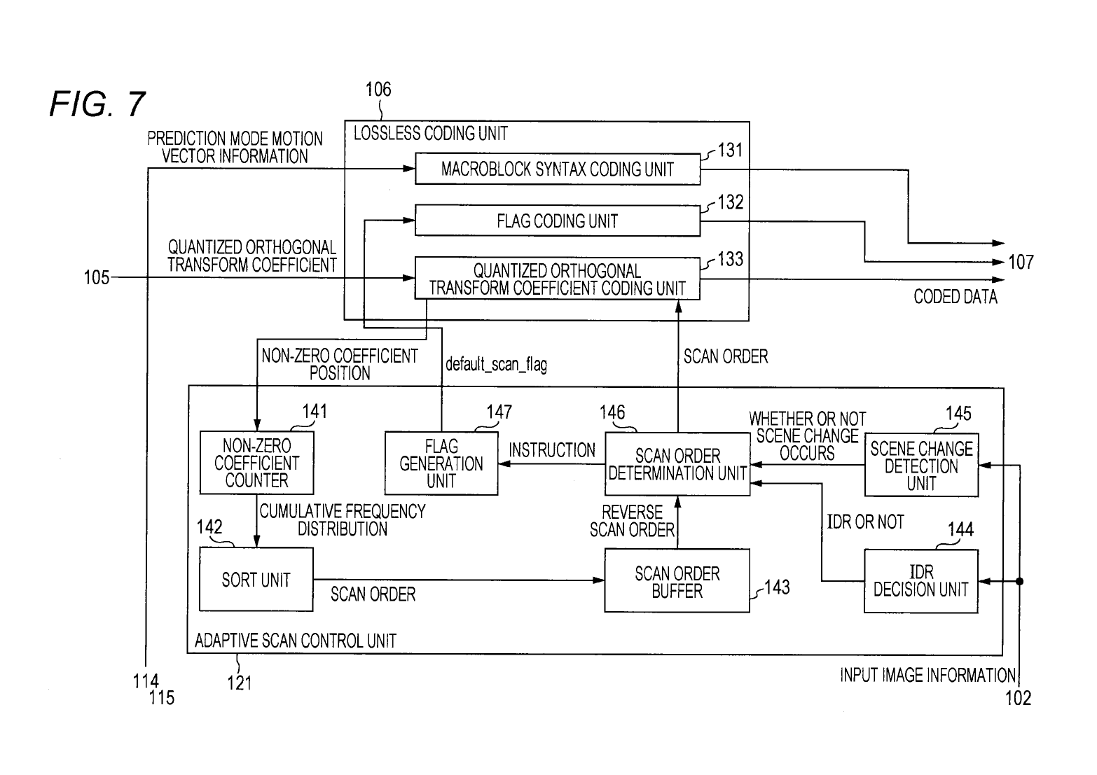

FIG. 7 is a block diagram illustrating a main configuration example of the adaptive scan control unit 121 of the lossless coding unit 106 in FIG. 6.

As illustrated in FIG. 7, the lossless coding unit 106 has a macroblock syntax coding unit 131, a flag coding unit 132 and a quantized orthogonal transform coefficient coding unit 133.

Further, the adaptive scan control unit 121 has a non-zero coefficient counter 141, a sort unit 142, a scan order buffer 143, an IDR decision unit 144, a scene change detection unit 145, a scan order determination unit 146 and a flag generation unit 147.

The macroblock syntax coding unit 131 codes, for example, the prediction mode or motion vector information supplied from the intra prediction unit 114 or the motion prediction/compensation unit 115, and supplies the coded data to the accumulation buffer 107 as a syntax of the macroblock.

The flag coding unit 132 codes default_scan_flag generated by the flag generation unit 147, and supplies the coded data to the accumulation buffer 107.

The quantized orthogonal transform coefficient coding unit 133 codes the quantized orthogonal transform coefficients supplied from the quantization unit 105, and supplies the coded data to the accumulation buffer 107. In this case, the quantized orthogonal transform coefficient coding unit 133 acquires the scan order determined by the scan order determination unit 146, and scans and codes the quantized orthogonal transform coefficients according to this scan order.

Further, the quantized orthogonal transform coefficient coding unit 133 supplies information (non-zero coefficient position) indicating positions of non-zero coefficients in each macroblock (a partial area which is an orthogonal transform processing unit of an image) of the quantized orthogonal transform coefficients supplied from the quantization unit 105, to the non-zero coefficient counter 141.

The non-zero coefficient counter 141 of the adaptive scan control unit 121 acquires the non-zero coefficient positions from the quantized orthogonal transform coefficient coding unit 133, counts the non-zero coefficients at each pixel position in the macroblock and calculates a cumulative value per predetermined data amount such as a slice or a picture. The non-zero coefficient counter 141 supplies a cumulative frequency distribution which is the cumulative value of non-zero coefficients at each position in the macroblock, to the sort unit 142.

The sort unit 142 sorts each pixel position in the macroblock which is a partial area which is an orthogonal transform processing unit of an image, in order of the cumulative frequency based on the cumulative frequency distribution of the non-zero coefficients supplied from the non-zero coefficient counter 141, and determines this order as the scan order. When, for example, there are a plurality of pixel positions of the same cumulative frequency, these pixel positions are ranked and sorted according to a predetermined rule set in advance. The sort unit 142 supplies the determined scan order to the scan order buffer 143.

The scan order buffer 143 holds the scan order supplied from the sort unit 142 as the latest value of the update order which is the updated scan order. The scan order buffer 143 adequately supplies the update order to the scan order determination unit 146.

The IDR decision unit 144 refers to a NAL (Network Abstraction Layer) syntax of input image information supplied from the screen rearrangement buffer 102, and decides whether or not a processing target is an IDR picture. The IDR decision unit 144 supplies the decision result to the scan order determination unit 146. The NAL syntax relates to a NAL (Network Abstraction Layer) which is defined according to, for example, the AVC coding scheme, and an identifier nal_unit_type of a NAL header indicates whether or not the NAL syntax is a slice of the IDR picture.

The scene change detection unit 145 analyzes the input image information supplied from the screen rearrangement buffer 102, and detects occurrence of a scene change based on the analysis result. A method of detecting this scene change is arbitrary. When, for example, comparing histograms of pixel values or arbitrary statistical values such as average values between frames of the input image information and finding that the difference between the statistical values between the frames is greater than a predetermined criterion, that is, finding that a feature of an image significantly changes, the scene change detection unit 145 decides that a scene change occurs. The scene change detection unit 145 notifies whether or not a scene change occurs, to the scan order determination unit 146.

The scan order determination unit 146 determines whether to select the initial order held in advance or the update order supplied from the scan order buffer 143 based on, for example, an IDR decision result supplied from the IDR decision unit 144 or a detection result of a scene change supplied from the scene change detection unit 145.

When, for example, an image is an IDR picture or includes a scene change, a feature of an image is highly likely to significantly change, and therefore the scan order determination unit 146 determines the initial order which is a predetermined scan order set in advance as in conventional zigzag scanning as the scan order to prevent the coding efficiency from decreasing due to inappropriate use of the scan order with respect to the image, and notifies the initial order to the quantized orthogonal transform coefficient coding unit 133.

This initial order may be an arbitrary order, and is desirably a generally preferable scan order as in zigzag scanning defined in, for example, AVC.

Further, when, for example, an image is not an IDR picture or does not include a scene change, the scan order determination unit 146 determines as the scan order the update order which is a scan order updated according to an image and which is supplied from the scan order buffer 143, and notifies the update order to the quantized orthogonal transform coefficient coding unit 133.

The scan order determination unit 146 also supplies the determination result of the scan order to the flag generation unit 147.

The flag generation unit 147 sets a value of default_scan_flag according to the determination result, and supplies the value to the flag coding unit 132. When, for example, the initial order is selected as the scan order, the flag generation unit 147 sets the value of default_scan_flag to 1. Further, when, for example, the update order is selected as the scan order, the flag generation unit 147 sets the value of default_scan_flag to 0.

### [Update of Scan Order]

As descried above, the adaptive scan control unit 121 not only selects the initial order or the update order as the scan order of the quantized orthogonal transform coefficients in the lossless coding unit 106, but also updates the update order according to the cumulative frequency distribution of non-zero coefficients.

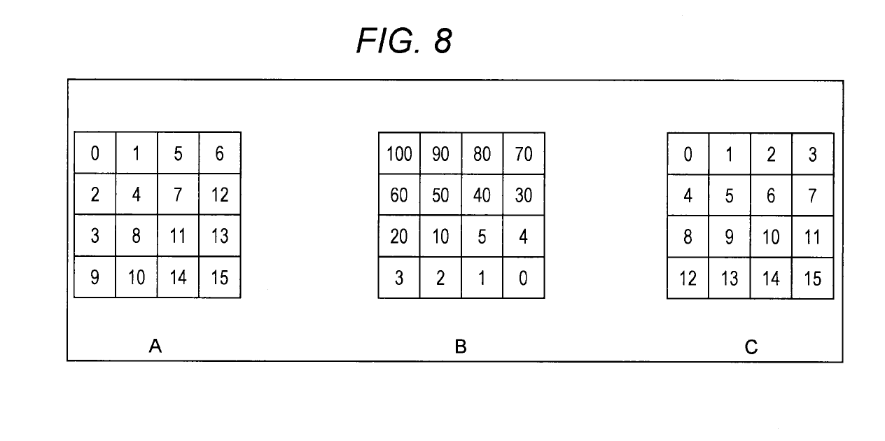

For example, as illustrated in FIG. 8, a zigzag scan order as indicated by A in FIG. 8 is set in advance as the initial order for a 4×4 block. In FIG. 8, each square indicates a pixel position in the block. A number in each square indicated by A in FIG. 8 indicates a scan order (an order from 0 to 15).

For example, in a given predetermined data unit (for example, a picture or a slice), a cumulative value of non-zero coefficients at each pixel position in the block shows a distribution as indicated by B in FIG. 8 as a result of counting non-zero coefficients of each block. In B in FIG. 8, a number in each square indicates the cumulative frequency of a non-zero coefficient.

The sort unit 142 of the adaptive scan control unit 121 rearranges the scan order in the frequency order of the non-zero coefficients as indicated by C in FIG. 8. A number in each square indicated by A in FIG. 8 indicates a scan order (an order from 0 to 15).

By making such a scan order, the quantized orthogonal transform coefficient coding unit 133 of the lossless coding unit 106 can scan first a pixel position at which a non-zero coefficient is highly likely to appear, so that it is possible to increase a zero-run value. That is, the lossless coding unit 106 can perform scanning according to a scan order which is more suitable for an image. Consequently, the image coding apparatus 100 can improve the coding efficiency.

In addition, when a processing target is a next data unit (for example, a picture or a slice), non-zero coefficients are newly counted. The above update order is updated per data unit using a count result of a past data unit.

Meanwhile, when an image is an IDR picture or includes a scene change, a feature of an image is highly likely to significantly change from a feature of a previous image (features of an image are less continuous), and therefore the scan order is set to the initial order. By so doing, the image coding apparatus 100 can prevent an image from being scanned according to an inappropriate scan order due to a significant difference between a feature of a current image and a feature of a past image on which the scan order is based, and prevent the coding efficiency from decreasing.

### [Coding Processing Flow]

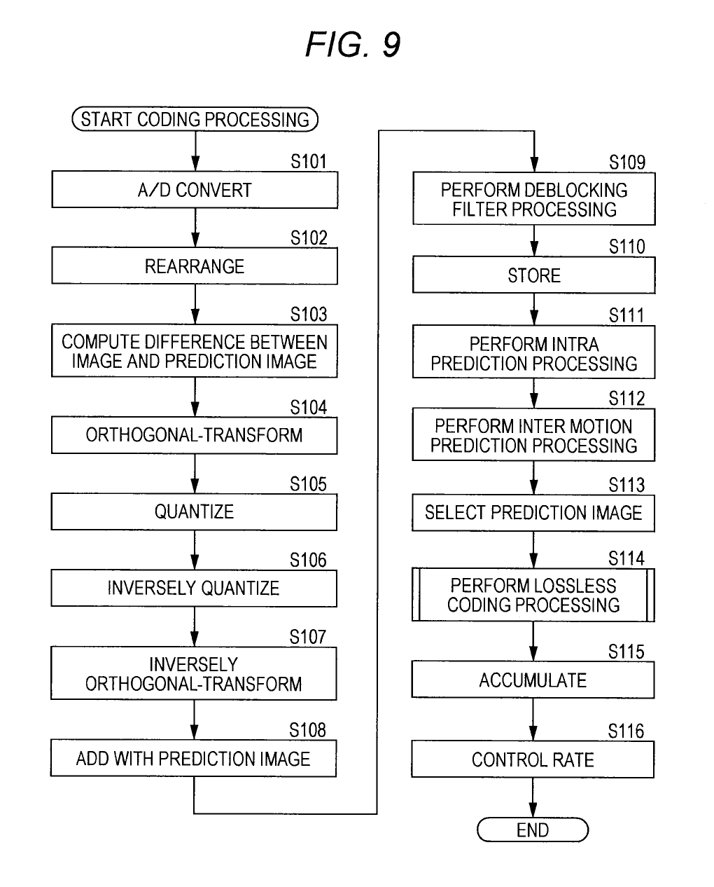

Next, a flow of each processing executed by the above image coding apparatus 100 will be described. First, an example of a flow coding processing will be described with reference to a flowchart in FIG. 9.

In step S101, the A/D conversion unit 101 A/D converts an inputted image. In step S102, the screen rearrangement buffer 102 stores the A/D converted image, and rearranges a display order of each picture to a coding order.

In step S103, the computation unit 103 computes a difference between the image rearranged by processing in step S102, and a prediction image. The prediction image is supplied to the computation unit 103 through the selection unit 116 from the motion prediction/compensation unit 115 upon inter prediction or from the intra prediction unit 114 upon intra prediction.

The data amount of difference data is smaller than original image data. Consequently, it is possible to compress the data amount compared to the image which is coded as is.

In step S104, the orthogonal transform unit 104 orthogonal-transforms difference information generated by processing in step S103. More specifically, orthogonal transform such as discrete cosine transform or Karhunen-Loeve transform is performed, and transform coefficients are outputted.

In step S105, the quantization unit 105 quantizes the orthogonal transform coefficients obtained by processing in step S104.

The difference information quantized by processing in step S105 is locally decoded as follows. That is, in step S106, the inverse quantization unit 108 inversely quantizes the quantized orthogonal transform coefficients (also referred to as “quantized coefficients”) generated by processing in step S105 according to characteristics matching characteristics of the quantization unit 105. In step S107, the inverse orthogonal transform unit 109 inversely orthogonal-transforms the orthogonal transform coefficients obtained by processing in step S106 according to characteristics matching characteristics of the orthogonal transform unit 104.

In step S108, the computation unit 110 adds the prediction image to the locally decoded difference information, and generates the locally decoded image (an image corresponding to an input to the computation unit 103). In step S109, the deblocking filter 111 filters the image generated by processing in step S108. By this means, block distortion is canceled.

In step S110, the frame memory 112 stores the image from which block distortion is canceled by processing in step S109. In addition, the image which is not filtered by the deblocking filter 111 is supplied from the computation unit 110 to the frame memory 112, and is stored.

In step S111, the intra prediction unit 114 performs intra prediction processing in the intra prediction mode. In step S112, the motion prediction/compensation unit 115 performs inter motion prediction processing of performing motion prediction or motion compensation in the inter prediction mode.

In step S113, the selection unit 116 determines an optimal prediction mode based on each cost function value outputted from the intra prediction unit 114 and the motion prediction/compensation unit 115. That is, the selection unit 116 selects one of the prediction image generated by the intra prediction unit 114 and the prediction image generated by the motion prediction/compensation unit 115.

Further, selection information indicating which one of these prediction images is selected is supplied to the intra prediction unit 114 or the motion prediction/compensation unit 115 from which the prediction image is selected. When the prediction image of the optimal intra prediction mode is selected, the intra prediction unit 114 supplies information (that is, intra prediction mode information) indicating the optimal intra prediction mode, to the lossless coding unit 106.

When the prediction image of the optimal inter prediction mode is selected, the motion prediction/compensation unit 115 outputs information indicating the optimal inter prediction mode and, if necessary, information matching the optimal inter prediction mode, to the lossless coding unit 106. The information matching the optimal inter prediction mode is, for example, motion vector information, flag information and reference frame information.

In step S114, the lossless coding unit 106 codes the transform coefficients quantized by processing in step S105. That is, the difference image (second order differential image in case of inter) is lossless-coded such as variable-length coded or arithmetic coded.

In addition, the lossless coding unit 106 codes a quantization parameter calculated in step S105, and adds the quantization parameter to the coded data.

Further, the lossless coding unit 106 codes information related to a prediction mode of the prediction image selected by processing in step S113, and adds the information to the coded data obtained by coding the differential image. That is, the lossless coding unit 106 also codes, for example, intra prediction mode information supplied from the intra prediction unit 114 or information matching the optimal inter prediction mode supplied from the motion prediction/compensation unit 115, and adds the information to the coded data.

In step S115, the accumulation buffer 107 accumulates the coded data outputted from the lossless coding unit 106. The coded data accumulated in the accumulation buffer 107 is adequately read, and transmitted to the decoding side through a channel.

In step S116, the rate control unit 117 controls a rate of a quantization operation of the quantization unit 105 based on the compressed image accumulated in the accumulation buffer 107 by processing in step S115, to prevent occurrence of an overflow or an underflow.

When processing in step S116 is finished, coding processing is finished.

### [Lossless Coding Processing Flow]

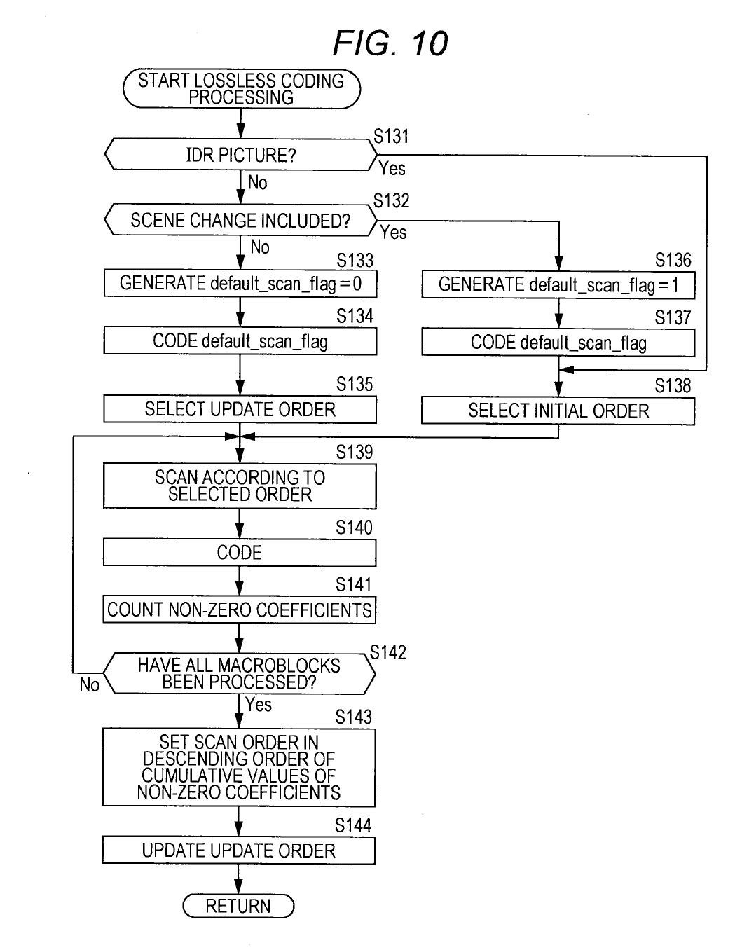

Next, an example of a flow of lossless coding processing executed in step S114 in FIG. 9 will be described with reference to a flowchart in FIG. 10.

When lossless coding processing is started, the IDR decision unit 144 decides in step S131 whether or not a current image is an IDR picture. When deciding that the current image is not an IDR picture, the IDR decision unit 144 advances processing to step S132.

In step S132, the scene change detection unit 145 decides whether or not the current image includes a scene change. When deciding that the current image does not include a scene change, the scene change detection unit 145 advances processing to step S133.

When the current image is not an IDR picture or does not include a scene change, a feature of the current image is more likely to be similar to a feature of a previous image. Then, in step S133, the flag generation unit 147 generates a value of default_scan_flag taking 0 such that the update order is selected as the scan order (the initial order is not selected) (default_scan_flag=0). In step S134, the flag coding unit 132 codes this default_scan_flag.

In step S135, the scan order determination unit 146 selects the update order as the scan order of the quantized orthogonal transform coefficients in the lossless coding unit 106 (quantized orthogonal transform coefficient coding unit 133), and advances processing to step S139.

Further, when deciding in step S132 that the current image does not include a scene change, the scene change detection unit 145 advances processing to step S136.

The scene change occurs, and therefore the feature of the current image is less likely to be similar to a feature of a previous image. Then, in step S137, the flag generation unit 147 generates a value of default_scan_flag taking 1 such that the initial order is selected as the scan order (default_scan_flag=0). In step S137, the flag coding unit 132 codes this default_scan_flag, and advances processing to step S138.

Further, in step S131, when deciding that the current image is an IDR picture, the IDR decision unit 144 advances processing to step S138. That is, in this case, the flag generation unit 147 does not generate default_scan_flag. The decoding side can also easily detect the IDR picture from a NAL syntax. Consequently, it is possible to easily learn that the initial order is selected, without default_scan_flag. When an image is the IDR picture, by skipping transmission of this default_scan_flag, the image coding apparatus 100 can prevent the coding efficiency from decreasing due to transmission of this default_scan_flag.

In step S138, the scan order determination unit 146 selects the initial order as the scan order of the quantized orthogonal transform coefficients in the lossless coding unit 106 (quantized orthogonal transform coefficient coding unit 133), and advances processing to step S139.

The quantized orthogonal transform coefficient coding unit 133 scans in step S139 the quantized orthogonal transform coefficients of a current macroblock according to the scan order (selection order) selected in step S135 or step S138, and codes the quantized orthogonal transform coefficients in order from the scanned orthogonal transform coefficients in step S140.

In step S141, the non-zero coefficient counter 141 counts and accumulates non-zero coefficients at each pixel position in the macroblock, in predetermined data units (for example, a picture or a slice).

In step S142, the non-zero coefficient counter 141 decides whether or not all macroblocks are processed in predetermined data units. When deciding that there is a macroblock which is not processed, the non-zero coefficient counter 141 returns processing to step S139, and repeats subsequent processing.

Further, when deciding in step S142 that all macroblocks are processed, the non-zero coefficient counter 141 advances processing to step S143.

In step S143, the sort unit 142 makes the scan order in order from higher cumulative values (an order matching a cumulative frequency distribution). In step S144, the scan order buffer 143 updates the update order to the scan order set in step S143.

When processing in step S144 is finished, the adaptive scan control unit 121 finishes lossless coding processing, returns processing to step S114 in FIG. 9 and repeats subsequent processing.

As described above, the adaptive scan control unit 121 adaptively controls the scan order in the lossless coding unit 106 according to the feature of the image, so that the image coding apparatus 100 can improve the coding efficiency.

### 2. Second Embodiment

### [Image Decoding Apparatus]

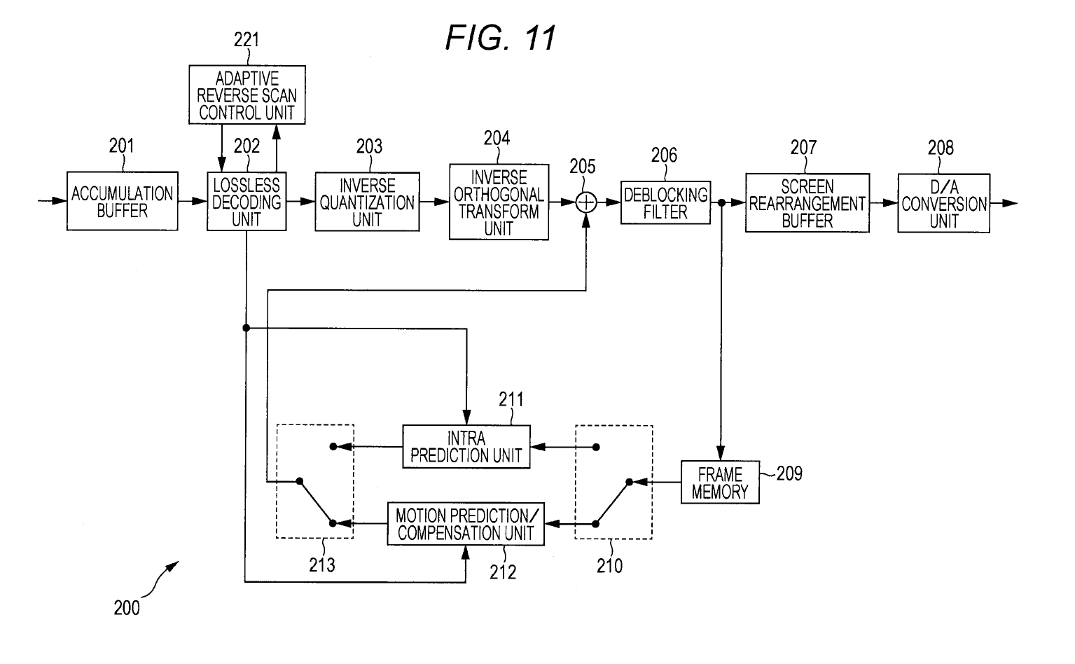

FIG. 11 is a block diagram illustrating a main configuration example of an image decoding apparatus. An image decoding apparatus 200 illustrated in FIG. 11 is a decoding apparatus which supports an image coding apparatus 100 in FIG. 6.

Coded data which is coded by the image coding apparatus 100 is transmitted to the image decoding apparatus 200 which supports this image coding apparatus 100 through a predetermined channel, and is decoded.

As illustrated in FIG. 11, the image decoding apparatus 200 has an accumulation buffer 201, a lossless decoding unit 202, an inverse quantization unit 203, an inverse orthogonal transform unit 204, a computation unit 205, a deblocking filter 206, a screen rearrangement buffer 207 and a D/A conversion unit 208. Further, the image decoding apparatus 200 has a frame memory 209, a selection unit 210, an intra prediction unit 211, a motion prediction/compensation unit 212 and a selection unit 213.

The image decoding apparatus 200 further has an adaptive reverse scan control unit 221.

The accumulation buffer 201 accumulates the transmitted coded data. This coded data is coded by the image coding apparatus 100. The lossless decoding unit 202 decodes the coded data read from the accumulation buffer 201 at a predetermined timing, according to a scheme matching the coding scheme of a lossless coding unit 106 in FIG. 6.

The lossless decoding unit 202 reversely scans the quantized orthogonal transform coefficients obtained by decoding the coded data, according to the reverse scan order determined by the adaptive reverse scan control unit 221, and rearranges the orthogonal transform coefficients from a one-dimensional array to a two-dimensional array.

The inverse quantization unit 203 inversely quantizes coefficient data (quantization coefficients) decoded and obtained by the lossless decoding unit 202, according to a scheme matching the quantization scheme of the quantization unit 105 in FIG. 7.

The inverse quantization unit 203 supplies the inversely quantized coefficient data, that is, orthogonal transform coefficients, to the inverse orthogonal transform unit 204. The inverse orthogonal transform unit 204 inversely orthogonal-transforms the orthogonal transform coefficients according to the scheme matching the orthogonal transform scheme of the orthogonal transform unit 104 in FIG. 6, and obtains decoded difference data corresponding to difference data which is not yet orthogonal-transformed by the image coding apparatus 100.

The decoded difference data obtained by performing inversely orthogonal-transform is supplied to the computation unit 205. Further, the computation unit 205 receives a supply of a prediction image from the intra prediction unit 211 or the motion prediction/compensation unit 212 through the selection unit 213.

The computation unit 205 adds the decoded difference data and the prediction image, and obtains decoded image data corresponding to image data from which the prediction image is not yet subtracted by the computation unit 103 of the image coding apparatus 100. The computation unit 205 supplies this decoded image data to the deblocking filter 206.

The deblocking filter 206 cancels block distortion of the supplied decoded image, and then supplies the decoded image to the screen rearrangement buffer 207.

The screen rearrangement buffer 207 rearranges the image. That is, a frame order which is rearranged for a coding order by the screen rearrangement buffer 102 in FIG. 6 is rearranged to the original display order. The D/A conversion unit 208 D/A converts the image supplied from the screen rearrangement buffer 207, and outputs the image to a display which is not illustrated to display.

An output of the deblocking filter 206 is further supplied to the frame memory 209.

The frame memory 209, the selection unit 210, the intra prediction unit 211, the motion prediction/compensation unit 212 and the selection unit 213 correspond to a frame memory 112, a selection unit 113, an intra prediction unit 114, a motion prediction/compensation unit 115 and a selection unit 116 of the image coding apparatus 100 in FIG. 7.

The selection unit 210 reads an image which is subjected to inter processing and which is referred to, from the frame memory 209, and supplies the images to the motion prediction/compensation unit 212. Further, the selection unit 210 reads the image used for intra prediction, from the frame memory 209, and supplies the image to the intra prediction unit 211.

The intra prediction unit 211 adequately receives a supply of, for example, information indicating an intra prediction mode obtained by decoding header information, from the lossless decoding unit 202. The intra prediction unit 211 generates a prediction image from the reference image acquired from the frame memory 209 based on this information, and supplies the generated prediction image to the selection unit 213.

The motion prediction/compensation unit 212 acquires information obtained by decoding header information (for example, prediction mode information, motion vector information, reference frame information, a flag and various parameters) from the lossless decoding unit 202.

The motion prediction/compensation unit 212 generates a prediction image from the reference image acquired from the frame memory 209 based on these pieces of information supplied from the lossless decoding unit 202, and supplies the generated prediction image to the selection unit 213.

The selection unit 213 selects the prediction image generated by the motion prediction/compensation unit 212 or the intra prediction unit 211, and supplies the prediction image to the computation unit 205.

The adaptive reverse scan control unit 221 adaptively controls a reverse scan order for transforming the quantized orthogonal transform coefficients obtained by decoding the coded data in the lossless decoding unit 202 from the one-dimensional array into the two dimensional array, according to the image.

That is, the adaptive reverse scan control unit 221 determines the reverse scan order to return the quantized orthogonal transform coefficients rearranged according to the scan order determined by the adaptive scan control unit 121 in FIG. 6 to the original array (such that rearrangement is performed in an order reverse from arrangement of the scan order).

The adaptive reverse scan control unit 221 acquires the quantized orthogonal transform coefficients decoded and obtained by the lossless decoding unit 202, observes a distribution of non-zero coefficients taking values which are non-zero, and updates the reverse scan order of the quantized orthogonal transform coefficients in the lossless decoding unit 202 according to the state of the distribution (update order). The adaptive reverse scan control unit 221 updates the update order using the distribution of non-zero coefficients in the image decoded in the past utilizing a high likelihood that images having similar features continue in a movie.

That is, the adaptive reverse scan control unit 221 updates the reverse scan order according the same method as the method of updating the scan order in the adaptive scan control unit 121 in FIG. 6 such that the update order of reverse scanning matches the update order of scanning (such that the order becomes the reverse order).

The adaptive reverse scan control unit 221 further decides an IDR picture or detects a scene change based on a syntax or flag information (default_scan_flag) included in coded data, and, in this case, determines a predetermined order (initial order) set in advance as the reverse scan order. Further, when a processing target is not an IDR picture and does not include a scene change, the adaptive reverse scan control unit 221 determines the update order as the reverse scan order.

That is, the adaptive reverse scan control unit 221 performs control of the reverse scan order matching control of the adaptive scan control unit 121 in FIG. 6, and sets the reverse scan order to the initial order under conditions that the adaptive scan control unit 121 selects the initial order and sets the reverse scan order to the update order under conditions that the adaptive scan control unit 121 selects the update order.

The lossless decoding unit 202 reversely scans the quantized orthogonal transform coefficients according to the reverse scan order determined by the adaptive reverse scan control unit 221 under control of the adaptive reverse scan control unit 221.

By arranging the above, the lossless decoding unit 202 can perform reverse scanning in the reverse order from the scan order in the lossless coding unit 106. That is, the lossless decoding unit 202 can accurately reversely scan the quantized orthogonal transform coefficients scanned by the lossless coding unit 106 according to characteristics of an image. Consequently, the image decoding apparatus 200 can accurately decode coded data coded by the image coding apparatus 100, so that it is possible to improve the coding efficiency.

### [Adaptive Reverse Scan Control Unit]

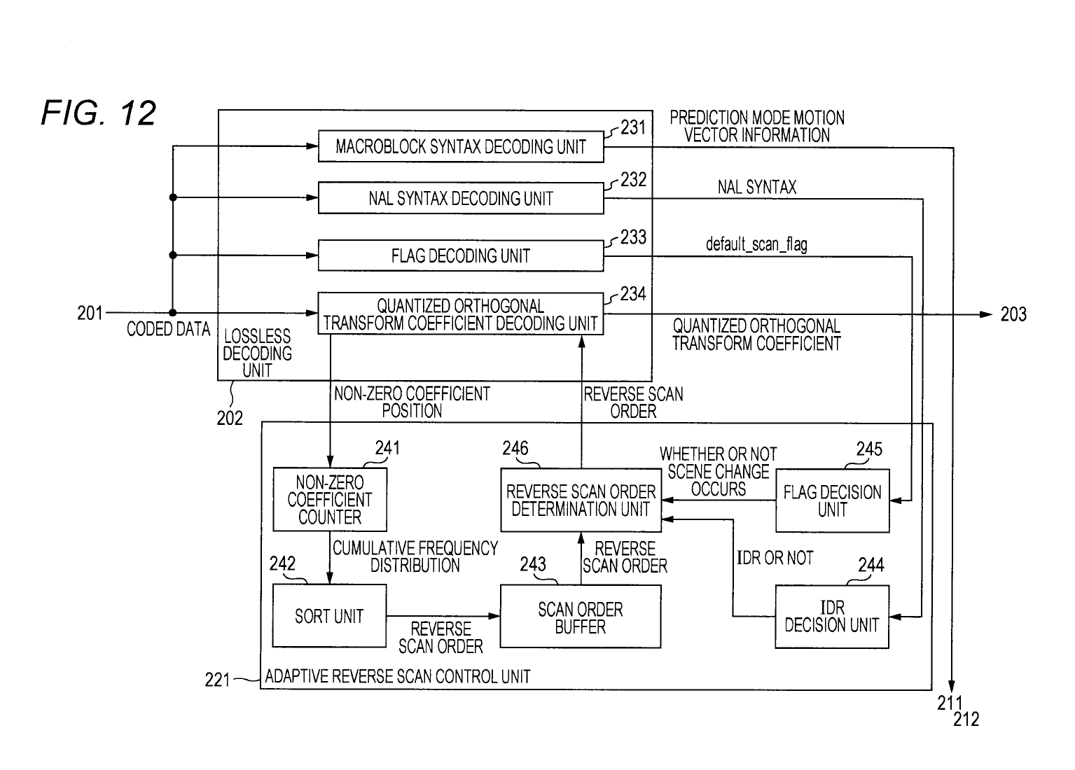

FIG. 12 is a block diagram illustrating a main configuration example of the adaptive reverse scan control unit 221 of the lossless decoding unit 202 in FIG. 11.

As illustrated in FIG. 12, the lossless decoding unit 202 has a macroblock syntax decoding unit 231, an NAL syntax decoding unit 232, a flag decoding unit 233 and a quantized orthogonal transform coefficient decoding unit 234.

Further, as illustrated in FIG. 12, the adaptive reverse scan control unit 221 has a non-zero coefficient counter 241, a sort unit 242, a reverse scan order buffer 243, an IDR decision unit 244, a flag decision unit 245 and a reverse scan order determination unit 246.

The macroblock syntax decoding unit 231 decodes coded data of a macroblock syntax supplied from the accumulation buffer 201, and supplies, for example, a prediction mode or motion vector information resulting from decoding, to the intra prediction unit 211 or the motion prediction/compensation unit 212.

The NAL syntax decoding unit 232 decodes coded data of a NAL syntax supplied from the accumulation buffer 201, and supplies the NAL syntax resulting from decoding to the IDR decision unit 244.

The flag decoding unit 233 decodes coded data of default_scan_flag supplied from the accumulation buffer 201, and supplies default_scan_flag resulting from decoding to the flag decision unit 245.

The quantized orthogonal transform coefficient decoding unit 234 decodes coded data of the quantized orthogonal transform coefficients supplied from the accumulation buffer 201, reversely scans the quantized orthogonal transform coefficients resulting from decoding according to the reverse scan order controlled by the adaptive reverse scan control unit 221, and supplies the rearranged quantized orthogonal transform coefficients to the inverse quantization unit 203.

Further, the quantized orthogonal transform coefficient decoding unit 234 supplies information indicating pixel positions of non-zero coefficients of the quantized orthogonal transform coefficients in a macroblock, to the non-zero coefficient counter 241.

The non-zero coefficient counter 241 counts the non-zero coefficients of the quantized orthogonal transform coefficients per pixel position in the macroblock, and supplies a cumulative value (cumulative frequency distribution) of a predetermined data unit (for example, a picture or a slice) of non-zero coefficients at each pixel position to the sort unit 242.

The sort unit 242 sorts each pixel position in the macroblock according to the cumulative frequency order based on the cumulative frequency distribution of the non-zero coefficients supplied from the non-zero coefficient counter 241, and determines the reverse order from the cumulative frequency order as the reverse scan order. When, for example, there are a plurality of pixel positions of the same cumulative frequency, the sort unit 242 ranks and sorts the pixel positions according to a predetermined rule set in advance. This rule matches the rule of the sort unit 142 (ranking is performed according to the reverse order from ranking performed by the sort unit 142). The sort unit 242 supplies the determined reverse scan order to the reverse scan order buffer 243.

The reverse scan order buffer 243 holds the update order of the reverse scan order. The reverse scan order buffer 243 holds the reverse scan order supplied from the sort unit 242 as the latest value of the update order which is the updated reverse scan order. The reverse scan order buffer 243 adequately supplies the update order to the reverse scan order determination unit 246.

The IDR decision unit 244 refers to a NAL syntax supplied from the NAL syntax decoding unit 232, and decides whether or not a processing target is an IDR picture. The IDR decision unit 244 supplies the decision result to the reverse scan order determination unit 246.

The flag decision unit 245 decides a value of default_scan_flag supplied from the flag decoding unit 233, and detects occurrence of a scene change. When default_scan_flag takes a value (for example, “1”) indicating occurrence of a scene change, the flag decision unit 245 notifies that the scene change has occurred to the reverse scan order determination unit 246. Further, when default_scan_flag takes a value (for example, “0”) indicating that a scene change does not occur, the flag decision unit 245 notifies that the scene change does not occur to the reverse scan order determination unit 246.

The reverse scan order determination unit 246 selects the initial order or the update order as the reverse scan order based on an IDR decision result supplied from the IDR decision unit 244 and a decision result as to whether or not a scene change occurs supplied from the flag decision unit 245, and notifies this selection result to the quantized orthogonal transform coefficient decoding unit 234.

That is, when, for example, an image is an IDR picture or includes a scene change, the image coding apparatus 100 performs scanning according to the initial order, and therefore the reverse scan order determination unit 246 determines as the reverse scan order the initial order which is a predetermined scan order set in advance as in conventional zigzag scanning and notifies the initial order to the quantized orthogonal transform coefficient coding unit 133.

In addition, the initial order of this reverse scan order is reverse from the initial order of the scan order of a scan order determination unit 146 of the image coding apparatus 100.

Further, when, for example, an image is not an IDR picture or does not include a scene change, the reverse scan order determination unit 246 determines as the reverse scan order the update order which is the reverse scan order updated according to the image and which is supplied from the reverse scan order buffer 243, and notifies the update order to the quantized orthogonal transform coefficient coding unit 133.

### [Decoding Processing Flow]

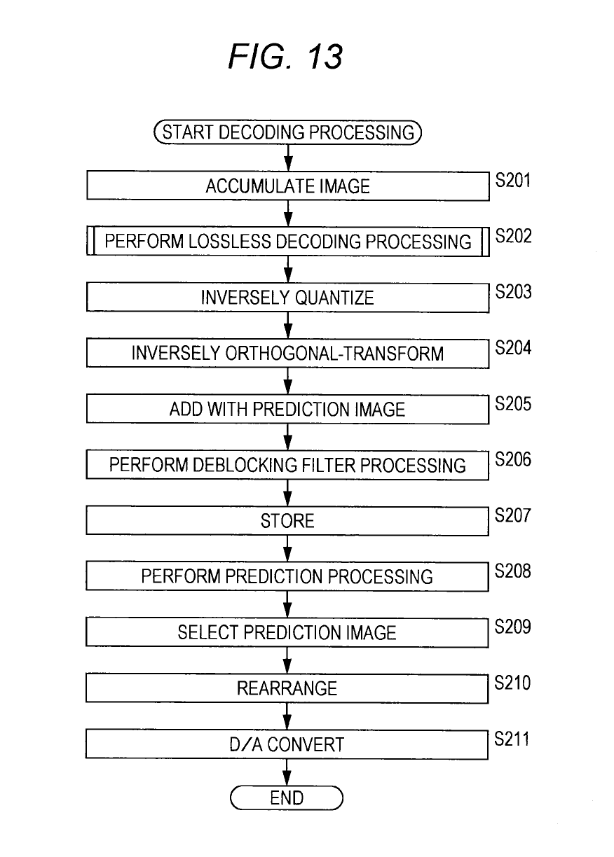

Next, a flow of each processing executed by the above image decoding apparatus 200 will be described. First, an example of a flow of decoding processing will be described with reference to a flowchart in FIG. 13.

When decoding processing is started, the accumulation buffer 201 accumulates transmitted coded data in step S201. In step S202, the lossless decoding unit 202 and the adaptive reverse scan control unit 221 decode coded data supplied from the accumulation buffer 201. That is, an I picture, a P picture and a B picture coded by the lossless coding unit 106 in FIG. 6 are decoded.

In this case, motion vector information, reference frame information, prediction mode information (an intra prediction mode or an inter prediction mode) and information such as a flag and a quantization parameter are decoded.

When prediction mode information is intra prediction mode information, prediction mode information is supplied to the intra prediction unit 211. When prediction mode information is inter prediction mode information, motion vector information matching prediction mode information is supplied to the motion prediction/compensation unit 212.

In step S203, the inverse quantization unit 203 inversely quantizes the quantized orthogonal transform coefficients decoded and obtained by the lossless decoding unit 202 according to a method supporting quantization processing in the quantization unit 105 in FIG. 6. In step S204, the inverse orthogonal transform unit 204 inversely orthogonal-transforms the orthogonal transform coefficients inversely quantized by the inverse quantization unit 203 according to a method supporting orthogonal transform processing in the orthogonal transform unit 104 in FIG. 6. By this means, difference information corresponding to an input (an output of the computation unit 103) of the orthogonal transform unit 104 in FIG. 6 is decoded.

In step S205, the computation unit 205 adds a prediction image to the difference information obtained by processing in step S204. By this means, the original image data is decoded.

In step S206, the deblocking filter 206 adequately filters the decoded image obtained by processing in step S205. By this means, block distortion is adequately canceled from the decoded image.

In step S207, the frame memory 209 stores the filtered decoded image.

In step S208, the intra prediction unit 211 or the motion prediction/compensation unit 212 performs prediction processing of each image according to prediction mode information supplied from the lossless decoding unit 202.

That is, when intra prediction mode information is supplied from the lossless decoding unit 202, the intra prediction unit 211 performs intra prediction processing in the intra prediction mode. Further, when the inter prediction mode information is supplied from the lossless decoding unit 202, the motion prediction/compensation unit 212 performs motion prediction processing in the inter prediction mode.

In step S209, the selection unit 213 selects the prediction image. That is, the selection unit 213 receives a supply of the prediction image generated by the intra prediction unit 211 or the prediction image generated by the motion prediction/compensation unit 212. The selection unit 213 selects the supplied prediction image, and supplies the prediction image to the computation unit 205. This prediction image is added to difference information by processing in step S205.

In step S210, the screen rearrangement buffer 207 rearranges frames of decoded image data. That is, the frame order of the decoded image data rearranged for coding by the screen rearrangement buffer 102 (FIG. 6) of the image coding apparatus 100 is rearranged to the original display order.

In step S211, the D/A conversion unit 208 D/A converts decoded image data with frames rearranged by the screen rearrangement buffer 207. This decoded image data is outputted to a display which is not illustrated, and the image of the decoded image data is displayed.

### [Lossless Decoding Processing Flow]

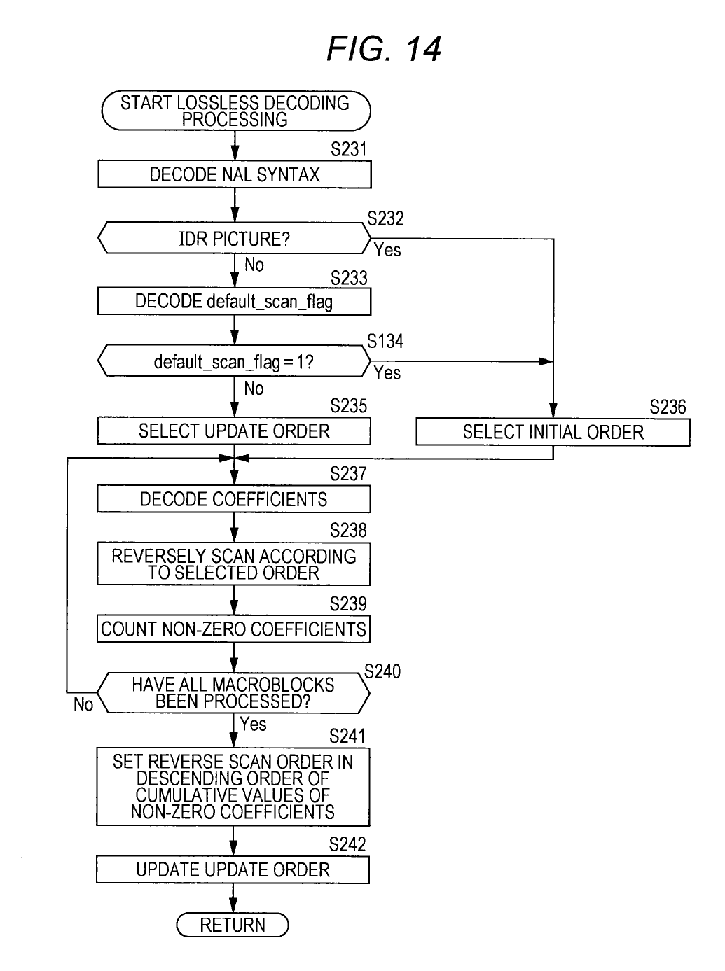

Next, an example of a flow of lossless decoding processing executed in step S203 in FIG. 13 will be described with reference to a flowchart in FIG. 14.

When lossless decoding processing is started, the NAL syntax decoding unit 232 decodes a NAL syntax in step S231. In step S232, the IDR decision unit 244 decides whether or not a processing target is an IDR picture based on information included in the decoded NAL syntax. When deciding that the processing target is not an IDR picture (orthogonal transform coefficients to be decoded are not an IDR picture), the IDR decision unit 244 advances processing to step S233.

In step S233, the flag decoding unit 233 decodes default_scan_flag. In step S234, the flag decision unit 245 decides whether or not a value of decoded default_scan_flag is 1 (a value indicating that the processing target includes a scene change). When deciding that the processing target does not include a scene change based on the value of default_scan_flag, the flag decision unit 245 advances processing to step S235.

In step S235, the reverse scan order determination unit 246 selects the update order as the reverse scan order. When selecting the update order, the reverse scan order determination unit 246 advances processing to step S237.

Further, when deciding in step S232 that the processing target is an IDR picture, the IDR decision unit 244 advances processing to step S236. Furthermore, when deciding in step S234 that the value of decoded default_scan_flag is 0 (a value indicating that the processing target does not include a scene change), the flag decision unit 245 advances processing to step S236.

In step S236, the reverse scan order determination unit 246 selects the initial order as the reverse scan order. When selecting the initial order, the reverse scan order determination unit 246 advances processing to step S237.

In step S237, the quantized orthogonal transform coefficient decoding unit 234 decodes coded data of the quantized orthogonal transform coefficients for a current macroblock. In step S238, the quantized orthogonal transform coefficient decoding unit 234 reversely scans the quantized orthogonal transform coefficients decoded and obtained in step S237 according to the order (the initial order or the update order) selected in step S235 or step S236, rearranges the quantized orthogonal transform coefficients in the two-dimensional array and supplies the quantized orthogonal transform coefficients to the inverse quantization unit 203.

In step S239, the non-zero coefficient counter 241 counts non-zero coefficients per pixel position in the macroblock.

In step S240, the non-zero coefficient counter 241 decides whether or not all macroblocks are processed for predetermined data units (for example, a picture or a slice). When deciding that there is a macroblock which is not processed, the non-zero coefficient counter 241 returns processing to step S237, and repeats subsequent processing.

Further, when deciding that in step S240 that all macroblocks are processed, the non-zero coefficient counter 241 advances processing to step S241.

In step S241, the sort unit 242 makes the reverse scan order in order from higher cumulative values of non-zero coefficients of the above predetermined data unit (for example, a picture or a slice).

In step S242, the reverse scan order buffer 243 updates the update order by holding the reverse scan order set in step S241.

When processing in step S242 is finished, the lossless decoding unit 202 and the adaptive reverse scan control unit 221 finish lossless decoding processing.

By performing each processing as described above, the image decoding apparatus 200 can accurately reproduce the reverse order from the scan order adaptively determined by the adaptive scan control unit 121 of the image coding apparatus 100 according to a feature of an image, and set this reverse order as the reverse scan order. Further, the image decoding apparatus 200 can accurately decide whether the image coding apparatus 100 adopts the initial order or the update order as the scan order, based on a NAL syntax of a code stream or flag information supplied from the image coding apparatus 100. That is, the image decoding apparatus 200 can accurately decode coded data generated by the image coding apparatus 100, so that it is possible to improve the coding efficiency.

In addition, although, according to the above first embodiment and second embodiment, a cumulative value of each pixel position of non-zero coefficients is used for a statistical value for determining an update order of a scan order or a reverse scan order, any statistical value other than this cumulative value such as an average value of cumulative values of non-zero coefficients may be used for this statistical value. The update order of the scan order or the reverse scan order may naturally be determined using a value other than a statistical value of non-zero coefficients.

Further, although a statistical value is calculated above per predetermined data unit such as a picture or a slice, this data unit is arbitrary.

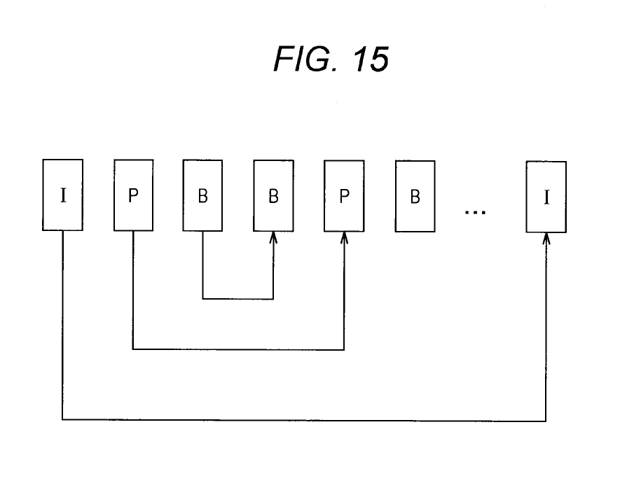

In addition, as illustrated in FIG. 15, the above-described adaptive control of a scan order and a reverse scan order may be performed independently for an I slice (I picture), a P slice (P picture) and a B slice (B picture) (control is independently performed per slice type or per picture type).

In this case, as illustrated in FIG. 15, the scan order and the reverse scan order of each slice (picture) are updated using a statistical value of non-zero coefficients of the same type of a slice (picture) in the past. For example, a scan order for the I slice is updated according to a frequency distribution of non-zero coefficients in the I slice processed immediately before, a scan order for the P slice is updated according to a frequency distribution of non-zero coefficients in the P slice processed immediately before and a scan order for a B slice is updated according to a frequency distribution of non-zero coefficients in the B slice processed immediately before.

Also in this case, a statistical value used to update the scan order and the reverse scan order is naturally arbitrary. By, for example, using different statistical values to update scan orders and reverse scan orders for the I slice, the P slice and the B slice, the scan orders and the reverse scan orders may be updated independently based on different statistical values.

Further, in case of the I slice, different scan scenes may be adopted according to an intra prediction mode. In case of an interslice, different scan schemes may naturally be adopted according to a motion compensation partition mode such as 16×16 or 16×8.

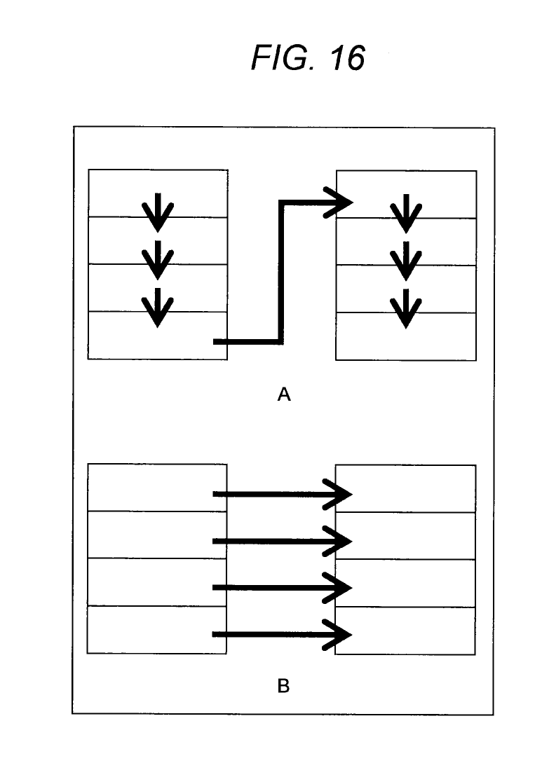

Further, when a single picture is divided into a plurality of slices and processed as illustrated in FIG. 16, although a scan order may be updated based on a statistical value of non-zero coefficients in a slice processed immediately before as indicated by A in FIG. 16, a scan order may be updated based on a statistical value of non-zero coefficients in a slice at the same position as in a picture processed immediately before as indicated by B in FIG. 16. When parallel processing is performed in slice units, the scheme indicated by B in FIG. 16 needs to be used.

Further, a scan order adopted by the image coding apparatus 100 may be transmitted to the image decoding apparatus 200. By so doing, the image decoding apparatus 200 can easily find the accurate reverse scan order according to this scan order. Meanwhile, by reproducing the accurate scan order (reverse scan order) in the image decoding apparatus 200 without transmitting the scan order as described above, it is possible to further improve the coding efficiency.

Although a scan order and a reverse scan order are updated above using a statistical value of non-zero coefficients in an image processed in the past, the present invention is not limited to this, and a scan order and a reverse scan order may be updated using a statistical value of non-zero coefficients in a current image (a scan order or a reverse scan order updated based on a current image is used to process the current image).

For example, in FIG. 7, the quantized orthogonal transform coefficient coding unit 133 holds quantized orthogonal transform coefficients of predetermined data units (for example, slices or pictures) supplied from the quantization unit 105, the non-zero coefficient counter 141 finds a cumulative frequency distribution of non-zero coefficients of the orthogonal transform coefficients, the sort unit 142 sets a scan order and the scan order buffer 143 updates an update order.

Further, when the scan order determination unit 146 selects the update order, the quantized orthogonal transform coefficient coding unit 133 scans the orthogonal transform coefficients which are held, per macroblock according to the update order.

By so doing, the lossless coding unit 106 can perform scanning according to the scan order which is more suitable for a feature of an image.

Meanwhile, in this case, the image decoding apparatus 200 cannot reproduce the update order (scan order) adopted in this way, and therefore the image coding apparatus 100 needs to transmit the adopted update order (scan order) to the image decoding apparatus 200.

Although a scan order and a reverse scan order are updated according to a cumulative frequency distribution of non-zero coefficients above, a threshold for determining whether or not to update the scan order and the reverse scan order may be provided. When, for example, an appearance frequency of non-zero coefficients is less biased and a cumulative frequency distribution is uniform, even if scanning is performed according to any order, the coding efficiency does not significantly differ. Consequently, a load may be reduced by skipping an update of the update order in this case. In this case, the initial order may be further selected as the scan order and the reverse scan order.

Further, although an update order which is adaptively updated or an initial order is selected according to characteristics of an image (for example, a cumulative frequency distribution of non-zero coefficients), the present invention is not limited to this, and one of a plurality of scan orders prepared in advance may be adaptively selected according to characteristics of an image (for example, a cumulative frequency distribution of non-zero coefficients). For example, the optimal scan order may be selected from a plurality of scan orders prepared in advance based on the frequency distribution of non-zero coefficients. The same also applies to the reverse scan order.

Further, the above-described control of a scan order and a reverse scan order may be applied only to an extended macroblock (a macroblock larger than a predetermined size) as proposed in Non-Patent Document 1.

Furthermore, although a scan order for scanning quantized orthogonal transform coefficients is controlled above, this technique is applicable to any processing as long as the technique controls the scan order (rearrangement order) for transforming arbitrary coefficient data from the two-dimensional array to the one-dimensional array. For example, orthogonal transform coefficients may not be quantized. Further, data to be scanned may not be orthogonal transform coefficients, and may be coefficient data generated by transforming image data by another transform processing different from orthogonal transform. The same also applies to reverse scanning.

Although the example has been described using an image coding apparatus which performs coding according to a scheme based on AVC and an image decoding apparatus which performs decoding according to a scheme based on AVC, an applicable range of the present invention is not limited to this, and the present invention is applicable to an image coding apparatus which performs orthogonal transform processing and coding processing of scanning orthogonal transform coefficients according to a predetermined scan order and an image decoding apparatus.

Further, the above-described information such as default_scan_flag may be added to, for example, an arbitrary position of coded data, or the information and coded data may be separately transmitted to a decoding side. For example, the lossless coding unit 106 may describe these pieces of information in a bit stream as a syntax. Further, the lossless coding unit 106 may store these pieces of information in a predetermined area as auxiliary information, and transmit these pieces of information. For example, these pieces of information may be stored in a parameter set (for example, a header of a sequence or a picture) such as SEI (Suplemental Enhancement Information).

Further, the lossless coding unit 106 may separately transmit these pieces of information and coded data (as another file) from the image coding apparatus 100 to the image decoding apparatus 200. In this case, although it is necessary to clarify a correspondence between these pieces of information and coded data (it is necessary to enable the decoding side to learn the correspondence), a method thereof is arbitrary. For example, table information indicating the correspondence may be additionally created, or link information indicating corresponding data may be embedded in each data.

### 3. Third Embodiment

### [Personal Computer]

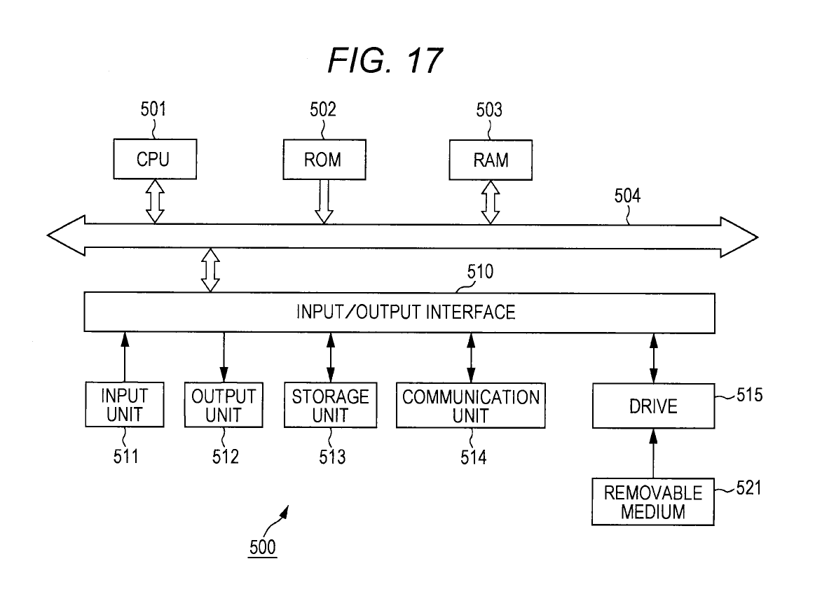

The above series of processing can be executed by hardware or can be executed by software. In this a personal computer as illustrated in, for example, FIG. 17 may be configured.

In FIG. 17, a CPU (Central Processing Unit) 501 of a personal computer 500 executes various processing according to a program stored in a ROM (Read Only Memory) 502 or a program loaded from a storage unit 513 to a RAM (Random Access Memory) 503. For example, data which the CPU 501 requires to execute various processing is also adequately stored in the RAM 503.

The CPU 501, the ROM 502 and the RAM 503 are connected to each other through a bus 504. An input/output interface 510 is also connected to this bus 504.

The input/output interface 510 is connected with an input unit 511 which includes a keyboard and a mouse, a display which is formed with a CRT (Cathode Ray Tube) or a LCD (Liquid Crystal Display), an output unit 512 which has speakers, the storage unit 513 which is configured by a hard disk and a communication unit 514 which is configured by a modem. The communication unit 514 performs communication processing through a network including Internet.

The input/output interface 510 is also connected with a drive 515 when necessary and is adequately attached a removable medium 521 such as a magnetic disk, an optical disk, a magnetooptical disk or a semiconductor memory, and a computer program read from the removable medium 521 is installed in the storage unit 513 when necessary.

When the above series of processing are executed by software, a program configuring this software is installed from a network or a recoding medium.

Apart from an apparatus body as illustrated in, for example, FIG. 17, this recording medium is not only configured by the removable medium 521 such as a magnetic disk (including a flexible disk), an optical disk (including a CD-ROM (Compact Disc-Read Only Memory) and a DVD (Digital Versatile Disc)), a magnetooptical disk (including a (MD (Mini Disc)) or a semiconductor memory on which a program distributed to distribute a program to users is recorded, but also configured by a hard disk such as the ROM 502 on which a program distributed to users in a state where the program is installed in the apparatus body in advance and the storage unit 513.

In addition, a program executed by the computer may be a program of executing processing in time series in order described in this description, or may be a program of executing processing in parallel or at a necessary timing when the program is invoked.

Further, in this description, steps for describing a program recorded on a recoding medium naturally include processing performed in time series in described order and also include processing executed in parallel or individually if not processed in time series.

Furthermore, in this description, a system refers to an entire apparatus which includes a plurality of devices (apparatuses).

Still further, a configuration which has been described above as one apparatus (or a processing unit) may be divided and configured as a plurality of apparatuses (or processing units). By contrast with this, a configuration which has been described above as a plurality of apparatuses (or processing units) may be collectively configured as one apparatus (or a processing unit). Further, configurations other than the above configurations may naturally be added to the configuration of each apparatus (or each processing unit). Furthermore, when the configuration and the operation of the entire system are substantially the same, part of a configuration of a given apparatus (or a processing unit) may be included in a configuration of another apparatus (or another processing unit). That is, the embodiments of the present invention are not limited to the above embodiments, and can be variously modified within a scope which does not deviate from the spirit of the present invention.

For example, the above image coding apparatus and image decoding apparatus are applicable to arbitrary electronic appliances. Hereinafter, examples thereof will be described.

### 4. Fourth Embodiment

### [Television Receiver]

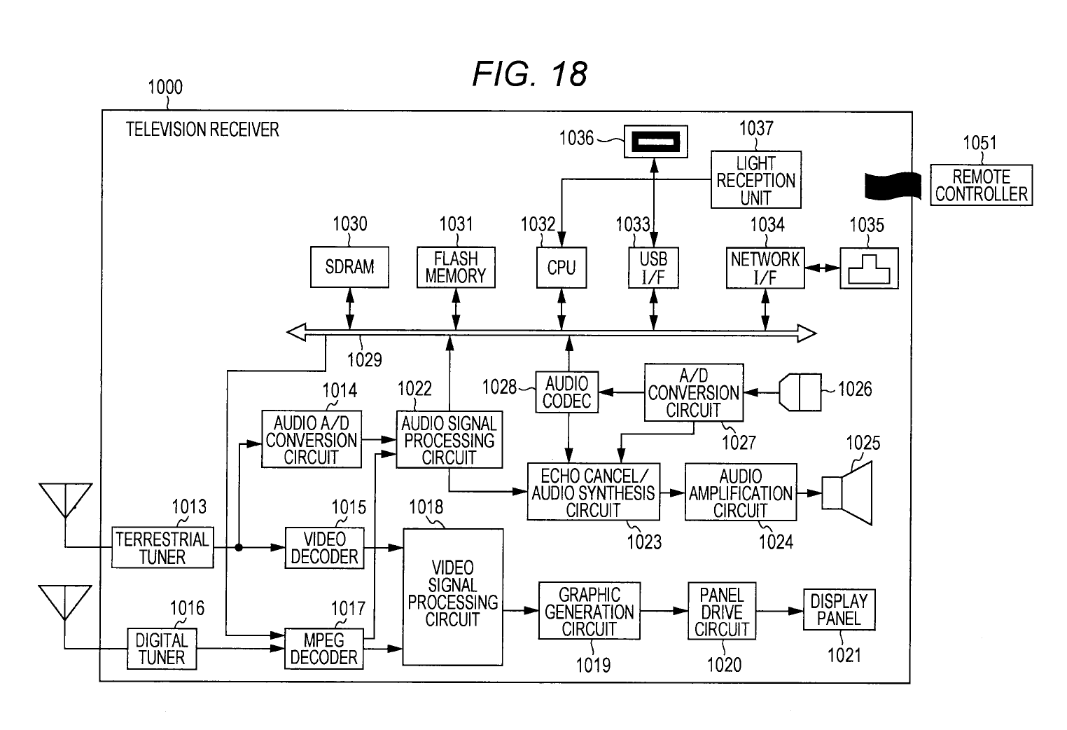

FIG. 18 is a block diagram illustrating a main configuration example of a television receiver which uses an image decoding apparatus 200.

A television receiver 1000 illustrated in FIG. 18 has a terrestrial tuner 1013, a video decoder 1015, a video signal processing circuit 1018, a graphic generation circuit 1019, a panel drive circuit 1020 and a display panel 1021.

The terrestrial tuner 1013 receives and demodulates an broadcast wave signal of terrestrial analog broadcasting, acquires a video signal and supplies the video signal to the video decoder 1015. The video decoder 1015 applies decoding processing to the video signal supplied from the terrestrial tuner 1013, and supplies a resulting digital component signal to the video signal processing circuit 1018.

The video signal processing circuit 1018 applies predetermined processing such as noise cancelation to video data supplied from the video decoder 1015, and supplies the resulting video data to the graphic generation circuit 1019.

The graphic generation circuit 1019 generates, for example, video data of a program displayed on a display panel 1021 or image data supplied through a network and obtained by processing based on an application, and supplies the generated video data and image data to the panel drive circuit 1020. Further, the graphic generation circuit 1019 also adequately performs processing of generating video data (graphic) for displaying a screen utilized by a user to select an item, and supplying video data obtained by superimposing the video data on video data of a program, to the panel drive circuit 1020.

The panel drive circuit 1020 drives the display panel 1021 based on the data supplied from the graphic generation circuit 1019, and displays video images of the program and various screens on the display panel 1021.

The display panel 1021 is formed with, for example, a LCD (Liquid Crystal Display), and displays, for example, video images of a program under control of the panel drive circuit 1020.

Further, the television receiver 1000 also has an audio A/D (Analog/Digital) conversion circuit 1014, an audio signal processing circuit 1022, an echo cancel/audio synthesis circuit 1023, an audio amplification circuit 1024 and a speaker 1025.

The terrestrial tuner 1013 acquires not only a video signal but also an audio signal by demodulating the received broadcast wave signal. The terrestrial tuner 1013 supplies the acquired audio signal to the audio A/D conversion circuit 1014.

The audio A/D conversion circuit 1014 applies A/D conversion processing to the audio signal supplied from the terrestrial tuner 1013, and supplies the resulting digital audio signal to the audio signal processing circuit 1022.

The audio signal processing circuit 1022 applies predetermined processing such as noise cancelation to the audio data supplied from the audio A/D conversion circuit 1014, and supplies the resulting audio data to the echo cancel/audio synthesis circuit 1023.

The echo cancel/audio synthesis circuit 1023 supplies the audio data supplied from the audio signal processing circuit 1022, to the audio amplification circuit 1024.

The audio amplification circuit 1024 applies D/A conversion processing and amplification processing to the audio data supplied from the echo cancel/audio synthesis circuit 1023, adjusts the audio data to a predetermined sound volume and then outputs an audio from the speaker 1025.

Further, television receiver 1000 also has a digital tuner 1016 and a MPEG decoder 1017.

The digital tuner 1016 receives a broadcast wave signal of digital broadcasting (digital terrestrial broadcasting, or BS (Broadcasting Satellite)/CS (Communications Satellite) digital broadcasting) through an antenna, demodulates the broadcast wave signal, acquires MPEG-TS (Moving Picture Experts Group-Transport Stream), and supplies MPEG-TS to the MPEG decoder 1017.

The MPEG decoder 1017 cancels scrambling applied to MPEG-TS supplied from the digital tuner 1016, and extracts a stream including program data which is a playback target (viewing target). The MPEG decoder 1017 decodes audio packets configuring the extracted stream, supplies resulting audio data to the audio signal processing circuit 1022, decodes video packets configuring the stream and supplies resulting video data to the video signal processing circuit 1018. Further, the MPEG decoder 1017 supplies EPG (Electronic Program Guide) data which is extracted from MPEG-TS, to the CPU 1032 through a channel which is not illustrated.

The television receiver 1000 uses the above image decoding apparatus 200 as the MPEG decoder 1017 which decodes video image packets in this way. In addition, MPEG-TS transmitted from, for example, a broadcasting station is coded by the image coding apparatus 100.

Similar to the image decoding apparatus 200, the MPEG decoder 1017 can specify a reverse scan order matching a scan order adopted by the image coding apparatus 100 based on a NAL syntax or default_scan_flag. Consequently, the MPEG decoder 1017 can accurately decode coded data coded by scanning quantized orthogonal transform coefficients according to the scan order adaptively controlled according to a feature of an image, so that it is possible to improve a coding efficiency.

Similar to video data supplied from the video decoder 1015, the video data supplied from the MPEG decoder 1017 is applied predetermined processing in the video signal processing circuit 1018, is adequately superimposed, for example, the generated video data in the graphic generation circuit 1019 and is supplied to the display panel 1021 through the panel drive circuit 1020, so that the image is displayed.

Similar to audio data supplied from the audio A/D conversion circuit 1014, the voice data supplied from the MPEG decoder 1017 is applied predetermined processing in the audio signal processing circuit 1022, is supplied to the audio amplification circuit 1024 through the echo cancel/audio synthesis circuit 1023 and is applied D/A conversion processing and amplification processing. As a result, an audio which is adjusted to a predetermined sound volume is outputted from the speaker 1025.

Further, the television receiver 1000 also has a microphone 1026 and an A/D conversion circuit 1027.

The A/D conversion circuit 1027 receives a signal of a user's voice taken in by the microphone 1026 provided in the television receiver 1000 for voice conversion, applies A/D conversion processing to the received audio signal and supplies the resulting digital audio data to the echo cancel/audio synthesis circuit 1023.

When data of the user's (user A) voice of the television receiver 1000 is supplied from the A/D conversion circuit 1027, the echo cancel/audio synthesis circuit 1023 echo-cancels the audio data of the user A and has the speaker 1025 output the audio data obtained by being synthesized with another audio data through the audio amplification circuit 1024.

Further, the television receiver 1000 also has an audio codec 1028, an internal bus 1029, a SDRAM (Synchronous Dynamic Random Access Memory) 1030, a flash memory 1031, a CPU 1032, a USB (Universal Serial Bus) I/F 1033 and a network I/F 1034.

The A/D conversion circuit 1027 receives a signal of a user's voice taken in by the microphone 1026 provided in the television receiver 1000 for voice conversion, applies A/D conversion processing to the received audio signal and supplies the resulting digital audio data to the audio codec 1028.

The audio codec 1028 converts the audio data supplied from the A/D conversion circuit 1027 into data of a predetermined format to be transmitted through the network, and supplies the data to the network I/F 1034 through the internal bus 1029.

The network I/F 1034 is connected to the network through a cable attached to a network terminal 1035. The network I/F 1034 transmits the audio data supplied from the audio codec 1028 to, for example, another apparatus connected to the network. Further, the network I/F 1034 receives through the network terminal 1035, for example, the audio data transmitted from another apparatus connected through the network, and supplies the audio data to the audio codec 1028 through the internal bus 1029.

The audio codec 1028 converts the audio data supplied from the network I/F 1034 into data of a predetermined format, and supplies the data to the echo cancel/audio synthesis circuit 1023.

The echo cancel/audio synthesis circuit 1023 echo-cancels the audio data supplied from the audio codec 1028, and has the speaker 1025 output the audio data obtained by being synthesized with another audio data through the audio amplification circuit 1024.

The SDRAM 1030 stores various items of data which the CPU 1032 requires to perform processing.

The flash memory 1031 stores a program executed by the CPU 1032. The program stored in the flash memory 1031 is read by the CPU 1032 at a predetermined timing such as a timing when the television receiver 1000 is activated. In the flash memory 1031, EPG data acquired through digital broadcasting and data acquired from a predetermined server through the network are also stored.

For example, in the flash memory 1031, MPEG-TS including content data acquired from the predetermined server through the network under control of the CPU 1032 is stored. The flash memory 1031 supplies this MPEG-TS to the MPEG decoder 1017 through the internal bus 1029 under control of, for example, the CPU 1032.

The MPEG decoder 1017 processes this MPEG-TS similar to MPEG-TS supplied from the digital tuner 1016. Thus, the television receiver 1000 can receive content data including video images and audios through the network, decode the content data using the MPEG decoder 1017, and display the video images and output audios.

Further, the television receiver 1000 also has a light reception unit 1037 which receives an infrared signal transmitted from a remote controller 1051.

The light reception unit 1037 receives infrared ray from the remote controller 1051, and outputs a control code which is demodulated and obtained and which indicates content of a user's operation, to the CPU 1032.

The CPU 1032 executes the program stored in the flash memory 1031, and controls the entire operation of the television receiver 1000 according to, for example, the control code supplied from the light reception unit 1037. Each unit of the CPU 1032 and the television receiver 1000 is connected through a channel which is not illustrated.

The USB I/F 1033 transmits and receives data to and from an external device of the television receiver 1000 which is connected through a USB cable attached to the USB terminal 1036. The network I/F 1034 connects to the network through a cable attached to the network terminal 1035, and transmits and receives data other than audio data to and from various apparatuses connected to the network.

Even when a broadcast wave signal received through an antenna or quantized orthogonal transform coefficients of content data acquired through the network are scanned according to a scan order adaptively controlled according to a feature of an image and are encoded, the television receiver 1000 can accurately decode the coded data by using the image decoding apparatus 200 as the MPEG decoder 1017 and improve the coding efficiency.

### 5. Fifth Embodiment

### [Mobile Telephone]

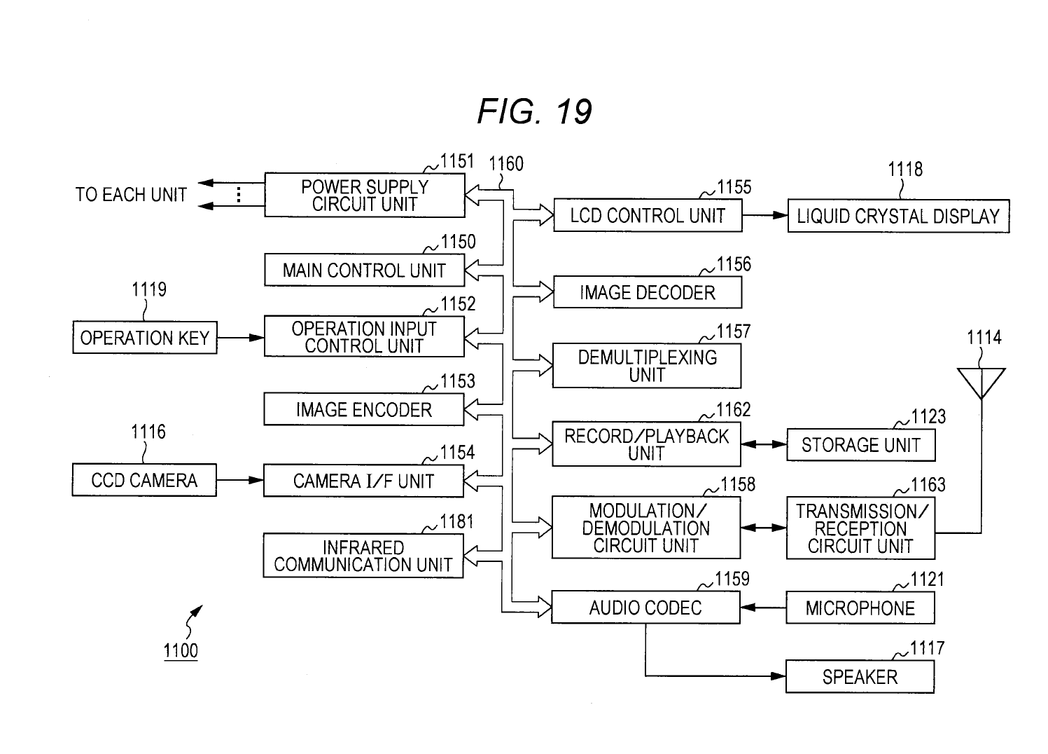

FIG. 19 is a block diagram illustrating a main configuration example of a mobile telephone using an image coding apparatus 100 and an image decoding apparatus 200.

A mobile telephone 1100 illustrated in FIG. 19 has a main control unit 1150 which is configured to perform overall control of each unit, a power supply circuit unit 1151, an operation input control unit 1152, an image encoder 1153, a camera I/F unit 1154, a LCD control unit 1155, an image decoder 1156, a demultiplexing unit 1157, a record/playback unit 1162, a modulation/demodulation circuit unit 1158 and an audio codec 1159. These units are connected through a bus 1160.

Further, the mobile telephone 1100 has an operation key 1119, a CCD (Charge Coupled Devices) camera 1116, a liquid crystal display 1118, a storage unit 1123, a transmission/reception circuit unit 1163, an antenna 1114, a microphone 1121 and a speaker 1117.

When a call is ended or a power key is turned on by a user's operation, the power supply circuit unit 1151 places the mobile telephone 1100 in an activated state by supplying power to each unit from a battery pack.

The mobile telephone 1100 performs various operations of, for example, transmitting and receiving audio signals, transmitting and receiving electronic mails and image data, capturing images and recording data in various modes such as a voice communication mode or a data communication mode based on control by the main control unit 1150 which has, for example, a CPU, a ROM and a RAM.

In, for example, the voice communication mode, the mobile telephone 1100 has the audio codec 1159 convert an audio signal collected by the microphone 1121 into digital audio data, has the modulation/demodulation circuit unit 1158 apply spread spectrum processing to the digital audio data and has the transmission/reception circuit unit 1163 apply digital/analog conversion processing and frequency conversion processing of the digital audio data. The mobile telephone 1100 transmits a transmit signal resulting from this conversion processing, to a base station which is not illustrated through an antenna 1114. The transmit signal (audio signal) transmitted to the base station is supplied to a mobile telephone of a communicating party through a public telephone network.

Further, in, for example, the voice communication mode, the mobile telephone 1100 has the transmission/reception circuit unit 1163 amplify a signal received at the antenna 1114 and perform frequency conversion processing and analog/digital conversion processing of the received signal, has the modulation/demodulation circuit unit 1158 perform inverse spread spectrum processing and has the audio codec 1159 convert the signal into an analog audio signal. The mobile telephone 1100 has the speaker 1117 output the analog audio signal resulting from this conversion.

Further, when, for example, an electronic mail is transmitted in a data communication mode, the mobile telephone 1100 has the operation input control unit 1152 receive text data of the electronic mail inputted by operating the operation key 1119. The mobile telephone 1100 has the main control unit 1150 process this text data, and has the liquid crystal display 1118 display the text image as an image through the LCD control unit 1155.

Further, the mobile telephone 1100 has the main control unit 1150 generate electronic mail data based on the text data or a user's instruction received by the operation input control unit 1152. The mobile telephone 1100 has the modulation/demodulation circuit unit 1158 perform spread spectrum processing of the electronic mail data, and has the transmission/reception circuit unit 1163 perform digital/analog conversion processing and frequency conversion processing of the electronic mail data. The mobile telephone 1100 transmits a transmit signal resulting from this conversion processing, to a base station which is not illustrated through an antenna 1114. A transmit signal (electronic mail) transmitted to a base station is supplied to a predetermined destination through, for example, the network and a mail server.

Further, when, for example, receiving an electronic mail in the data communication mode, the mobile telephone 1100 has the transmission/reception circuit unit 1163 receive the signal transmitted from the base station through the antenna 1114, amplify the signal and perform frequency conversion processing and analog/digital conversion processing of the signal. The mobile telephone 1100 has the modulation/demodulation circuit unit 115B perform spread spectrum processing of this received signal, and restore the original electronic mail data. The mobile telephone 1100 has the liquid crystal display 1118 display the restored electronic mail data through the LCD control unit 1155.

In addition, the mobile telephone 1100 can record (store) the received electronic mail data in the storage unit 1123 through the record/playback unit 1162.

This storage unit 1123 is an arbitrary rewritable storage medium. The storage unit 1123 may be, for example, a semiconductor memory such as a RAM or a built-in flash memory, a hard disk, or a removable medium such as a magnetic disk, an magnetooptical disk, an optical disk, a USB memory or a memory card. Naturally, other media may be employed.

When, for example, transmitting image data in the data communication mode, the mobile telephone 1100 has the CCD camera 1116 capture an image and generate image data. The CCD camera 1116 has an optical device such a lens and a diaphragm and a CCD as a photoelectric conversion element, and captures an image of a subject, converts an intensity of received light into an electrical signal and generates image data of the image of the subject. The CCD camera 1116 has the image encoder 1153 code the image data through the camera I/F unit 1154, and converts the image data into coded image data.

The mobile telephone 1100 uses the above image coding apparatus 100 as the image encoder 1153 which performs such processing. Similar to the image coding apparatus 100, the image encoder 1153 adaptively controls a scan order of quantized orthogonal conversion coefficients according to a feature of an image. Consequently, the image encoder 1153 can perform scanning according to a scan order which is more suitable for the feature of the image, so that it is possible to increase a zero-run value and improve the coding efficiency.

In addition, the mobile telephone 1100 has the audio codec 1159 simultaneously analog/digital convert and code an audio collected by the microphone 1121 while the CCD camera 1116 captures an image, and code the audio.

The mobile telephone 1100 has the demultiplexing unit 1157 multiplex the coded image data supplied from the image encoder 1153 and the digital audio data supplied from the audio codec 1159 according to a predetermined scheme. The mobile telephone 1100 has the modulation/demodulation circuit unit 1158 perform spread spectrum processing of the resulting multiplex data, and has the transmission/reception circuit unit 1163 perform digital/analog conversion processing and frequency conversion processing of the multiplex data. The mobile telephone 1100 transmits a transmit signal resulting from this conversion processing, to a base station which is not illustrated through an antenna 1114. A transmit signal (image data) transmitted to a base station is supplied to a communicating party through, for example, the network.

In addition, when no image data is transmitted, the mobile telephone 1100 can also have the liquid crystal display 1118 display the image data generated by the CCD camera 1116 through the LCD control unit 1155 without the image encoder 1153.

Further, when, for example, receiving data of a movie file linked to a simple homepage in the data communication mode, the mobile telephone 1100 has the transmission/reception circuit unit 1163 receive the signal transmitted from the base station through the antenna 1114, amplify the data and perform frequency conversion processing and analog/digital conversion processing of the data. The mobile telephone 1100 has the modulation/demodulation circuit unit 1158 perform inverse spread spectrum processing of this received signal, and restore the original electronic mail data. The mobile telephone 1100 has the demultiplexing unit 1157 demultiplex the multiplex data into coded image data and audio data.

The mobile telephone 1100 has the image decoder 1156 decode the coded image data to generate a playback movie data, and has the liquid crystal display 1118 display the playback movie data through the LCD control unit 1155. By this means, movie data included in a movie file linked to a simple homepage is displayed on the liquid crystal display 1118.

The mobile telephone 1100 uses the image decoding apparatus 200 as the image decoder 1156 which performs such processing. That is, similar to the image decoding apparatus 200, the image decoder 1156 can specify a reverse scan order matching a scan order adopted by the image coding apparatus 100 based on a NAL syntax or default_scan_flag. Consequently, the image decoder 1156 can accurately decode coded data coded by scanning quantized orthogonal transform coefficients according to the scan order adaptively controlled according to a feature of an image, so that it is possible to improve a coding efficiency.

In this case, the mobile telephone 1100 simultaneously has the audio codec 1159 convert digital audio data into an analog audio signal, and has the speaker 1117 output the analog audio signal. By this means, audio data included in a movie file linked to a simple homepage is played back.

In addition, similar to an electronic mail, the mobile telephone 1100 can record (store) the received data linked to, for example, a homepage, in the storage unit 1123 through the record/playback unit 1162.

Further, the mobile telephone 1100 has the main control unit 1150 analyze a two-dimensional code captured by the CCD camera 1116, and acquire information recorded in the two-dimensional code.

Furthermore, the mobile telephone 1100 can communicate with an external device by way of infrared ray using the infrared communication unit 1181.

The mobile telephone 1100 can adaptively control a scan order of quantized orthogonal transform coefficients generated from image data when the image data generated by, for example, the CCD camera 1116 is coded and transmitted by using the image coding apparatus 100 as the image encoder 1153, according to a feature of an image, perform scanning according to the scan order which is more suitable for the feature of the image, increase a zero-run value and improve the coding efficiency.

Further, even when, for example, quantized orthogonal transform coefficients of a movie file linked to, for example, a simple homepage are scanned according to the scan order adaptively controlled according to a feature of an image and coded, the mobile telephone 1100 can accurately decode the coded data using the image decoding apparatus 200 as the image decoder 1156 and improve the coding efficiency.

In addition, although the mobile telephone 1100 uses the CCD camera 1116 above, an image sensor (CMOS image sensor) using a CMOS (Complementary Metal Oxide Semiconductor) may be used instead of this CCD camera 1116. Also in this case, similar to a case where the CCD camera 1116 is used, the mobile telephone 1100 can capture an image of a subject and generate image data of the image of the subject.

Further, although the mobile telephone 1100 has been described above, the image coding apparatus 100 and the image decoding apparatus 200 are applicable to any apparatus similar to the mobile telephone 1100 as along as the apparatus has the same image capturing function and communication function as this mobile telephone 1100 such as a PDA (Personal Digital Assistants), a smart phone, a UMPC (Ultra Mobile Personal Computer), a netbook, a notebook computer.

### 6. Six Embodiment

### [Hard Disk Recorder]

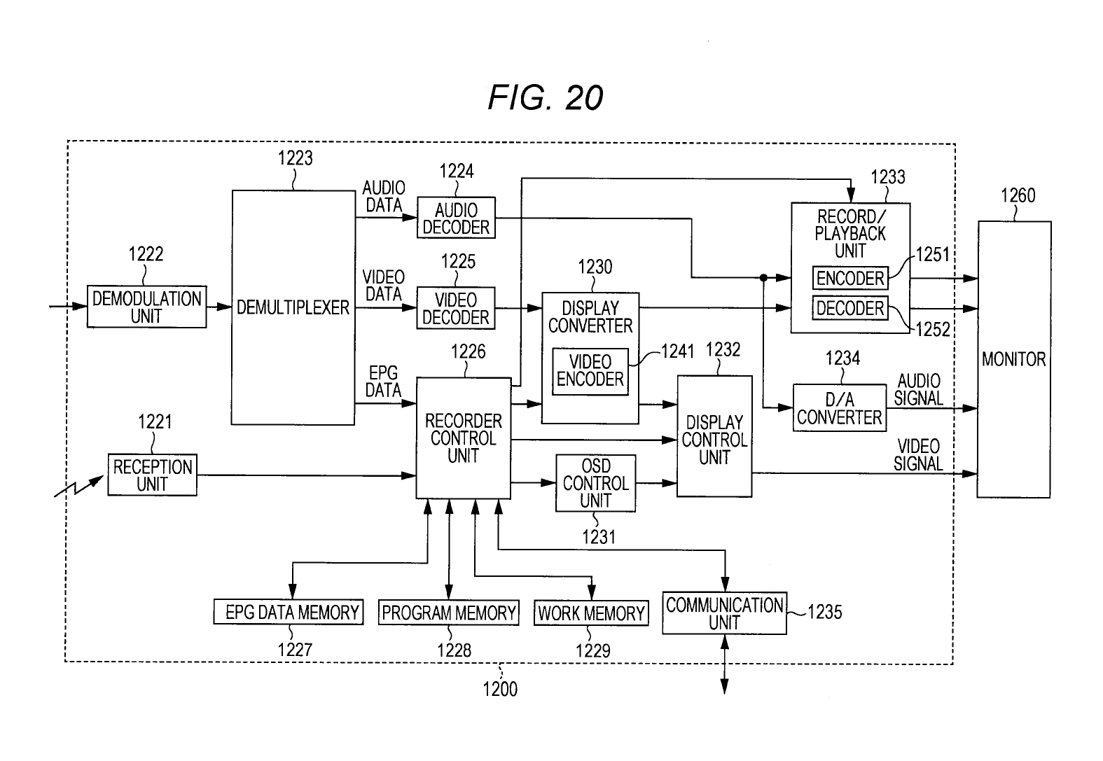

FIG. 20 is a block diagram illustrating a main configuration example of a hard disk recorder using an image coding apparatus 100 and an image decoding apparatus 200.

A hard disk recorder (HDD recorder) 1200 illustrated in FIG. 20 is an apparatus which stores, in a built-in hard-disk, audio data and video data of a broadcast program included in a broadcast wave signal (television signal) transmitted from a satellite antenna or an antenna on the ground and received by a tuner, and supplies the stored data to a user at a time matching a user's instruction.

The hard disk recorder 1200 can, for example, extract audio data and video data from a broadcast wave signal, adequately decode the audio data and the video data, and store the audio data and the video data in the built-in hard disk. Further, the hard disk recorder 1200 can, for example, acquire audio data and video data from another apparatus through a network, adequately decode the audio data and the video data, and store the audio data and the video data in the built-in hard disk.

Furthermore, the hard disk recorder 1200 can, for example, decode and supply the audio data and the video data recorded in the built-in hard disk to a monitor 1260, have the screen of the monitor 1260 display the image and have a speaker of the monitor 1260 output the audio. Still further, the hard disk recorder 1200 can also decode and supply to the monitor 1260 audio data and video data extracted from a broadcast wave signal acquired through a tuner or audio data and video data acquired from another apparatus through the network, have the screen of the monitor 1260 display the image and have the speaker of the monitor 1260 output the audio.

Other operations are naturally possible.

As illustrated in FIG. 20, the hard disk recorder 1200 has a reception unit 1221, a demodulation unit 1222, a demultiplexer 1223, an audio decoder 1224, a video decoder 1225 and a recorder control unit 1226. The hard disk recorder 1200 further has an EPG data memory 1227, a program memory 1228, a work memory 1229, a display converter 1230, an OSD (On Screen Display) control unit 1231, a display control unit 1232, a record/playback unit 1233, a D/A converter 1234 and a communication unit 1235.

Further, the display converter 1230 has a video encoder 1241. The record/playback unit 1233 has an encoder 1251 and a decoder 1252.

The reception unit 1221 receives an infrared signal from a remote controller (not illustrated), converts the infrared signal into an electrical signal and outputs the electrical signal to the recorder control unit 1226. The recorder control unit 1226 has, for example, a microprocessor, and executes various processing according to a program stored in the program memory 1228. In this case, the recorder control unit 1226 uses the work memory 1229 when necessary.

The communication unit 1235 is connected to the network, and performs communication processing with another apparatus through the network. For example, the communication unit 1235 is controlled by the recorder control unit 1226, communicates with a tuner (not illustrated) and outputs a channel tuning control signal mainly to the tuner.

The demodulation unit 1222 demodulates the signal supplied from the tuner, and outputs the signal to the demultiplexer 1223. The demultiplexer 1223 demultiplexes the data supplied from the demodulation unit 1222 into audio data, video data and EPG data, and outputs the audio data, the video data and the EPG data to the audio decoder 1224, the video decoder 1225 and the recorder control unit 1226, respectively.

The audio decoder 1224 decodes the inputted audio data, and outputs the audio data to the record/playback unit 1233. The video decoder 1225 decodes the inputted video data, and outputs the video data to the display converter 1230. The recorder control unit 1226 supplies the inputted EPG data to the EPG data memory 1227, and has the EPG data memory 1227 store the EPG data.

The display converter 1230 has the video encoder 1241 encode the video data supplied from the video decoder 1225 or the recorder control unit 1226 to video data in, for example, a NTSC (National Television Standards Committee) scheme, and outputs the video data to the record/playback unit 1233. Further, the display converter 1230 converts a size of a screen of the video data supplied from the video decoder 1225 or the recorder control unit 1226 into a size matching a size of the monitor 1260, and has the video encoder 1241 convert the data into video data in the NTSC format, convert the video data into an analog signal and output the analog signal to the display control unit 1232.

The display control unit 1232 superimposes an OSD signal outputted from the OSD (On Screen Display) control unit 1231 on the video signal inputted from the display converter 1230 under control of the recorder control unit 1226, outputs the signal to the display of the monitor 1260 to display.

The monitor 1260 also receives a supply of the audio data which is outputted from the audio decoder 1224, and which is converted into an analog signal by the D/A converter 1234. The monitor 1260 outputs this audio signal from a built-in speaker.

The record/playback unit 1233 has a hard disk as a storage medium which records, for example, video data and audio data.

For example, the record/playback unit 1233 has the encoder 1251 encode the audio data supplied from the audio decoder 1224. Further, the record/playback unit 1233 has the encoder 1251 encode the video data supplied from the video encoder 1241 of the display converter 1230. The record/playback unit 1233 has a multiplexer synthesize coded data of the audio data and coded data of the video data. The record/playback unit 1233 channel-codes and amplifies the synthesis data, and writes the data in the hard disk through a recording head.

The record/playback unit 1233 plays back and amplifies data recorded in the hard disk through a playback head, and has a demultiplexer demultiplex the data to audio data and video data. The record/playback unit 1233 has the decoder 1252 decode the audio data and the video data. The record/playback unit 1233 D/A converts the decoded audio data, and outputs the audio data to the speaker of the monitor 1260. Further, the record/playback unit 1233 D/A converts the decoded video data, and outputs the video data to the display of the monitor 1260.

The recorder control unit 1226 reads the latest EPG data from the EPG data memory 1227 based on a user's instruction indicated by an infrared signal received from the remote controller through the reception unit 1221, and supplies the EPG data to the OSD control unit 1231. The OSD control unit 1231 generates image data corresponding to the inputted EPG data, and outputs the image data to the display control unit 1232. The display control unit 1232 outputs the video data inputted from the OSD control unit 1231 to the display of the monitor 1260 to display. By this means, the display of the monitor 1260 displays EPG (Electronic Program Guide).

Further, the hard disk recorder 1200 can acquire various items of data such as video data, audio data and EPG data supplied from another apparatus through the network such as Internet.

The communication unit 1235 is controlled by the recorder control unit 1226 to acquire coded data such as video data, audio data and EPG data transmitted from another apparatus through the network, and supplies the coded data to the recorder control unit 1226. For example, the recorder control unit 1226 supplies coded data of the acquired video data or audio data, to the record/playback unit 1233, and has the hard disk store the coded data. In this case, the recorder control unit 1226 and the record/playback unit 1233 may perform processing such as re-encoding when necessary.

Further, the recorder control unit 1226 decodes coded data of the acquired video data or audio data, and supplies the resulting video data to the display converter 1230. The display converter 1230 processes the video data supplied from the recorder control unit 1226 similar to the video data supplied from the video decoder 1225, and supplies the video data to the monitor 1260 through the display control unit 1232 to display this image.

Further, upon display of this image, the recorder control unit 1226 may supply the decoded audio data to the monitor 1260 through the D/A converter 1234, and have the speaker output the audio.

Furthermore, the recorder control unit 1226 decodes coded data of the acquired EPG data, and supplies the decoded EPG data to the EPG data memory 1227.

The above hard disk recorder 1200 uses the image decoding apparatus 200 as a decoder built in the video decoder 1225, the decoder 1252 and the recorder control unit 1226. That is, similar to the image decoding apparatus 200, the decoder built in the video decoder 1225, the decoder 1252 and the recorder control unit 1226 can specify a reverse scan order matching a scan order adopted by the image coding apparatus 100 based on a NAL syntax or default_scan_flag. Consequently, the decoder built in the video decoder 1225, the decoder 1252 and the recorder control unit 1226 can accurately decode coded data coded by scanning quantized orthogonal transform coefficients according to the scan order adaptively controlled according to a feature of an image, so that it is possible to improve a coding efficiency.

Consequently, even when, for example, quantized orthogonal transform coefficients of video data (coded data) received by the tuner or the communication unit 1235 or video data (coded data) played back by the record/playback unit 1233 are scanned according to a scan order adaptively controlled according to a feature of an image and are coded, the hard disk recorder 1200 can accurately decode the coded data and improve the coding efficiency.

Further, the hard disk recorder 1200 uses the image coding apparatus 100 as the encoder 1251. Consequently, similar to the image coding apparatus 100, the encoder 1251 adaptively controls a scan order of quantized orthogonal conversion coefficients according to a feature of an image. Consequently, the encoder 1251 can perform scanning according to a scan order which is more suitable for the feature of the image, so that it is possible to increase a zero-run value and improve the coding efficiency.

Consequently, when, for example, generating coded data to be recorded in the hard disk, the hard disk recorder 1200 can adaptively control the scan order of the quantized orthogonal transform coefficients according to a feature of an image, perform scanning according to a scan order which is more suitable for the feature of the image, increase a zero-rum value and improve the coding efficiency.

In addition, although the hard disk recorder 1200 which records video data or audio data in the hard disk has been described above, any recording medium may naturally be used. Similar to the above hard disk recorder 1200, the image coding apparatus 100 and the image decoding apparatus 200 are applicable even to a recorder to which a recording medium such as a flash memory, an optical disk or a video tape other than a hard disk is applied.

### 7. Seventh Embodiment

### [Camera]

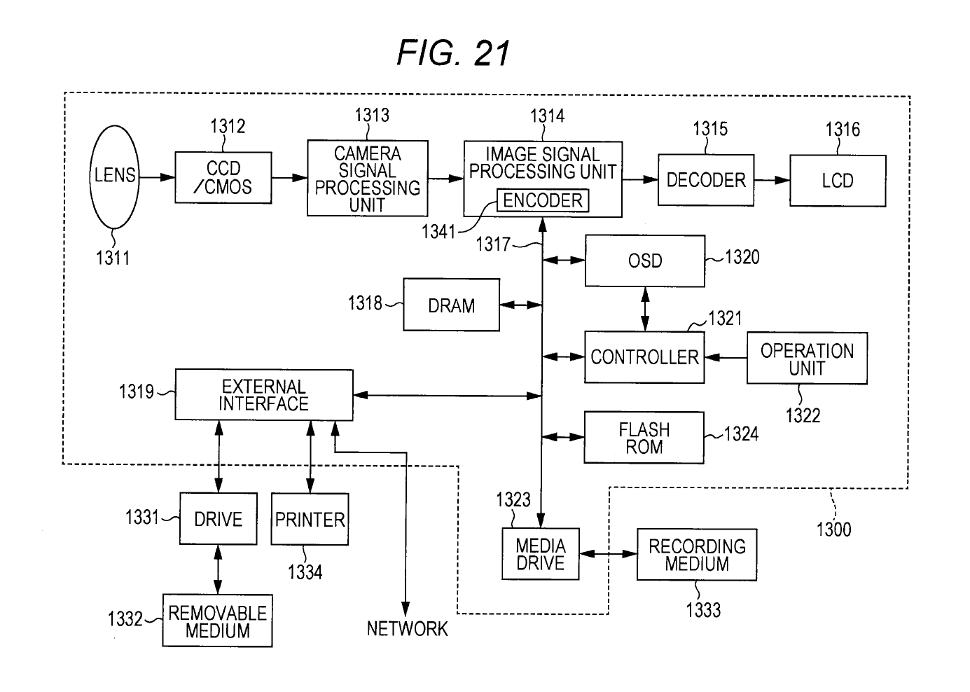

FIG. 21 is a block diagram illustrating a main configuration example of a camera using an image coding apparatus 100 and an image decoding apparatus 200.

A camera 1300 illustrated in FIG. 21 captures an image of a subject, displays the image of the subject on a LCD 1316 and records the image in a recording medium 1333 as image data.

A lens block 1311 allows light (that is, the image of the subject) to be incident on a CCD/CMOS 1312. The CCD/CMOS 1312 is an image sensor using a CCD or a CMOS, and converts an intensity of the received light into an electrical signal and supplies the electrical signal to the camera signal processing unit 1313.

The camera signal processing unit 1313 converts the electrical signal supplied from the CCD/CMOS 1312 into chrominance signals Y, Cr and Cb, and supplies the chrominance signals to an image signal processing unit 1314. The image signal processing unit 1314 applies predetermined image processing to an image signal supplied from the camera signal processing unit 1313 under control of a controller 1321, and has the encoder 1341 code the image signal. The image signal processing unit 1314 supplies the coded data generated by coding the image signal, to the decoder 1315. Further, the image signal processing unit 1314 acquires display data generated by an on screen display (OSD) 1320, and supplies the display data to the decoder 1315.

In the above processing, the camera signal processing unit 1313 adequately uses a DRAM (Dynamic Random Access Memory) 1318 connected through a bus 1317 to have the DRAM 1318 hold, for example, image data and coded data obtained by coding the image data when necessary.

The decoder 1315 decodes the coded data supplied from the image signal processing unit 1314, and supplies the resulting image data (decoded image data) to the LCD 1316. Further, the decoder 1315 supplies the display data supplied from the image signal processing unit 1314 to the LCD 1316. The LCD 1316 adequately synthesizes an image of the decoded image data and an image of the display data supplied from the decoder 1315, and displays the synthesis image.

The on screen display 1320 outputs a menu screen including, for example, symbols, letters or figures or the display data such as an icon under control of a controller 1321, and outputs the menu screen or the display data to the image signal processing unit 1314 through the bus 1317.

The controller 1321 executes various processing based on a signal indicating content instructed by a user by using an operation unit 1322, and controls, for example, the image signal processing unit 1314, the DRAM 1318, an external interface 1319, the on screen display 1320 and a media drive 1323 through the bus 1317. In a FLASH ROM 1324, a program or data which the controller 1321 requires to execute various processing is stored.

For example, instead of the image signal processing unit 1314 and the decoder 1315, the controller 1321 can code image data stored in the DRAM 1318, and decode coded data stored in the DRAM 1318. In this case, the controller 1321 may perform coding/decoding processing according to the same scheme as the coding/decoding scheme of the image signal processing unit 1314 or the decoder 1315, or may perform coding/decoding processing according to a scheme which the image signal processing unit 1314 or the decoder 1315 does not support.

Further, when, for example, the operation unit 1322 makes an instruction to start printing an image, the controller 1321 reads image data from the DRAM 1318, and supplies the image data to a printer 1334 connected to the external interface 1319 through the bus 1317 to print.

Furthermore, when, for example, the operation unit 1322 makes an instruction to record an image, the controller 1321 reads coded data from the DRAM 1318, and supplies the coded data to the recording medium 1333 attached to the media drive 1323 through the bus 1317 to store.

The recording medium 1333 may be an arbitrary readable removable medium such as an magnetic disk, a magnetooptical disk, an optical disk or a semiconductor memory. The recording medium 1333 may naturally be an arbitrary type of a removable medium, and may be a tape device, a disk or a memory card. The recording medium 1333 may naturally be a non-contact IC card.

Further, the media drive 1323 and the recording medium 1333 may be integrated to configure a non-portable recording medium such as a built-in hard disk drive or a SSD (Solid State Drive).

The external interface 1319 is formed with, for example, a USB input/output terminal, and is connected to the printer 1334 to print an image. Further, the external interface 1319 is connected with a drive 1331 when necessary and is adequately attached a removable medium 1332 such as a magnetic disk, an optical disk or a magnetooptical disk, and a computer program read therefrom is installed in the FLASH ROM 1324 when necessary.

Furthermore, the external interface 1319 has a network interface connected to a predetermined network such as a LAN or Internet. For example, the controller 1321 can read coded data from the DRAM 1318 according to an instruction from the operation unit 1322, and have the external interface 1319 supply the coded data to another apparatus connected through the network. Further, the controller 1321 can acquire through the external interface 1319 the coded data or the image data supplied from another apparatus through the network, have the DRAM 1318 have the coded data or the image data and supply the coded data or the image data to the image signal processing unit 1314.

The above camera 1300 uses the image decoding apparatus 200 as the decoder 1315. That is, similar to the image decoding apparatus 200, the decoder 1315 can specify a reverse scan order matching a scan order adopted by the image coding apparatus 100 based on an AL syntax or default_scan_flag. Consequently, the decoder 1315 can accurately decode coded data coded by scanning quantized orthogonal transform coefficients according to the scan order adaptively controlled according to a feature of an image, so that it is possible to improve a coding efficiency.

Consequently, even when, for example, quantized orthogonal transform coefficients of image data generated by the CCD/CMOS 1312, coded data of video data read from the DRAM 1318 or the recording medium 1333 or coded data of video data acquired through the network are scanned according to a scan order adaptively controlled according to a feature of an image and are coded, the camera 1300 can accurately decode the coded data and improve the coding efficiency.

Further, the camera 1300 uses the image coding apparatus 100 as the encoder 1341. Similar to the image coding apparatus 100, the encoder 1341 adaptively controls a scan order of quantized orthogonal conversion coefficients according to a feature of an image. Consequently, the encoder 1341 can perform scanning according to a scan order which is more suitable for the feature of the image, so that it is possible to increase a zero-run value and improve the coding efficiency.

Consequently, when, for example, generating coded data to be recorded in the DRAM 1318 or the recording medium 1333 or coded data provided to another apparatus, the camera 1300 can adaptively control the scan order of the quantized orthogonal transform coefficients according to a feature of an image, perform scanning according to a scan order which is more suitable for the feature of the image, increase a zero-rum value and improve the coding efficiency.

In addition, a decoding method of the image decoding apparatus 200 may be applied to decoding processing performed by the controller 1321. Similarly, a coding method of the image coding apparatus 100 may be applied to coding processing performed by the controller 1321.

Further, image data captured by the camera 1300 may be a movie or a still image.

The image coding apparatus 100 and the image decoding apparatus 200 are naturally applicable to apparatuses other than the above apparatus and systems.

The present invention is applicable to an image coding apparatus and image decoding apparatus which are used to receive image information (bit stream) compressed by orthogonal transform such as discrete cosine transform as in MPEG, H.26x and motion vector through a network medium such as satellite broadcasting, a cable TV, Internet or a mobile telephone or to process image information on a storage medium such as optical and magnetic disks or a flash memory.

In addition, the present invention can also employ the following configuration.

(1) An image processing apparatus has: a scan order control unit which controls a scan order for transforming coefficient data transformed from an image to be coded from a two-dimensional array into a one-dimensional array, according to a statistical value indicating a feature of the image; a scan unit which scans the coefficient data in the two-dimensional array according to the scan order controlled by the scan order control unit, and rearranges the coefficient data in the one-dimensional array; and a coding unit which codes the coefficient data rearranged in the one-dimensional array by the scan unit.

(2) With the image processing apparatus according to (1), the scan order control unit has: a calculation unit which calculates an appearance frequency of a non-zero coefficient of the coefficient data per pixel position in a partial area of the image which is a processing unit of transform processing of transforming the image and generating the coefficient data and in a predetermined data unit; and an update unit which updates the scan order in order of the appearance frequency of the non-zero coefficient of each pixel position in the partial area calculated by the calculation unit, and the scan unit scans the coefficient data according to the scan order updated by the update unit.

(3) With the image processing apparatus according to (2), the scan order control unit further has a determination unit which determines, as the scan order, one of an initial order which is a predetermined scan order set in advance and an update order which is the scan order updated by the update unit, and the scan unit scans the coefficient data according to the scan order determined by the determination unit from the initial order and the update order.

(4) With the image processing apparatus (3), the scan order control unit further has a decision unit which decides whether or not a processing target is an IDR picture, and the determination unit determines the initial order as the scan order when the decision unit decides that the processing target is the IDR picture, and determines the update order as the scan order when the decision unit decides that the processing target is not the IDR picture.

(5) With the image processing apparatus according to above (3) or (4), the scan order control unit further has a detection unit which detects a scene change, and the determination unit determines the initial order as the scan order when the detection unit detects the scene change in the processing target, and determines the update order as the scan order when the detection unit does not detect the scene change in the processing target.

(6) With the image processing apparatus according to one of (3) to (5), the scan order control unit further has a generation unit which generates flag information indicating whether the determination unit determines the initial order as the scan order or selects the update order, and the coding unit further codes the flag information generated by the generation unit.

(7) With the image processing apparatus according to one of above (3) to (6), the update unit updates the scan order to an order matching an order of the appearance frequency of the non-zero coefficient of each pixel position in the partial area of an image coded in a past.

(8) With the image processing apparatus according to one of above (3) to (7), when a single picture is divided into a plurality of slices and processed, the update unit updates the scan order according to the order of the appearance frequency of the non-zero coefficient of each pixel position in the partial area of a slice coded immediately before.

(9) With the image processing apparatus according to one of above (3) to (7), when a single picture is divided into a plurality of slices and processed, the update unit updates the scan order according to an order of the appearance frequency of the non-zero coefficient of each pixel position in the partial area of a slice at the same position as a current slice of a picture coded immediately before.

(10) With the image processing apparatus according to one of above (3) to (7), when a single picture is divided into a plurality of slices and each slice is processed in parallel, the update unit updates the scan order according to an order of the appearance frequency of the non-zero coefficient of each pixel position in the partial area of a slice at the same position as a current slice of a picture coded immediately before.

(11) With the image processing apparatus according to one of above (3) to (7), the update unit updates the scan order to an order matching an order of the appearance frequency of the non-zero coefficient of each pixel position in the partial area of a current image to be coded.

(12) With the image processing apparatus according to one of above (1) to (11), the scan control unit controls the scan order per size of a partial area of the image which is a processing unit of transform processing of transforming the image and generating the coefficient data.

(13) With the image processing apparatus according to one of above (1) to (11), the scan control unit controls the scan order per type of a current image.

(14) An image processing method of an image processing apparatus includes: at a scan order control unit, controlling a scan order for transforming coefficient data transformed from an image to be coded from a two-dimensional array into a one-dimensional array, according to a statistical value indicating a feature of the image; at a scan unit, scanning the coefficient data in the two-dimensional array according to the scan order, and rearranging the coefficient data in the one-dimensional array; and at a coding unit, coding the coefficient data rearranged in the one-dimensional array.

(15) The image processing apparatus has: a decoding unit which decodes coded data of an image generated by controlling a scan order for transforming coefficient data transformed from the image to be coded from a two-dimensional array into a one-dimensional array according to a statistical value indicating a feature of the image; a reverse scan order control unit which controls a reverse scan order for transforming the coefficient data obtained by decoding the coded data in the decoding unit, from the one-dimensional array into the two-dimensional array according to the statistical value indicating the feature of the image; and a reverse scan unit which reversely scans the coefficient data in the one-dimensional array according to the reverse scan order controlled by the reverse scan order control unit, and rearranges the coefficient data in the two-dimensional array.

(16) With the image processing apparatus according to above (15), the reverse scan order control unit has: a calculation unit which calculates an appearance frequency of a non-zero coefficient of the coefficient data per pixel position in a partial area of the image which is a processing unit of transform processing of transforming the image and generating the coefficient data and in a predetermined data unit; and an update unit which updates the reverse scan order in order of the appearance frequency of the non-zero coefficient of each pixel position in the partial area calculated by the calculation unit, and the reverse scan unit scans the coefficient data according to the reverse scan order updated by the update unit.

(17) With the image processing apparatus according to above (16), the reverse scan order control unit further has a determination unit which determines, as the reverse scan order, one of an initial order which is a predetermined reverse scan order set in advance and an update order which is the reverse scan order updated by the update unit, and the reverse scan unit reversely scans the coefficient data according to the reverse scan order determined by the determination unit from the initial order and the update order.

(18) With the image processing apparatus according to above (17), the reverse scan order control unit further has an IDR decision unit which decides whether or not a processing target is an IDR picture, and the determination unit determines the initial order as the reverse scan order when the IDR decision unit decides that the processing target is the IDR picture, and determines the update order as the reverse scan order when the decision unit decides that the processing target is not the IDR picture.

(19) With the image processing apparatus according to above (17) or (18), the reverse scan order control unit further has a flag decision unit which decides a value of flag information indicating whether a scan order of the coefficient data is the initial order or the update order, and the determination unit determines the initial order as the reverse scan order when the flag decision unit decides that the scan order of the coefficient data is the initial order, and determines the update order as the reverse scan order when the flag decision unit decides that the scan order of the coefficient data is the update order.

(20) An image processing method of an image processing apparatus includes: at a decoding unit, decoding coded data of an image generated by controlling a scan order for transforming coefficient data transformed from the image to be coded from a two-dimensional array into a one-dimensional array according to a statistical value indicating a feature of the image; at a reverse scan order control unit, controlling a reverse scan order for transforming the coefficient data obtained by decoding the coded data, from the one-dimensional array into the two-dimensional array according to the statistical value indicating the feature of the image; and at a reverse scan unit, reversely scanning the coefficient data in the one-dimensional array according to the reverse scan order, and rearranging the coefficient data in the two-dimensional array.

### REFERENCE SIGNS LIST

100 Image coding apparatus
106 Lossless coding unit
121 Adaptive scan control unit
131 Macroblock syntax coding unit
132 Flag coding unit
133 Quantized orthogonal transform coefficient coding unit
141 Non-zero coefficient counter
142 Sort unit
143 Scan order buffer
144 IDR decision unit
145 Scene change detection unit
146 Scan order determination unit
147 Flag generation unit
200 Image decoding device
202 Lossless decoding unit
221 Adaptive reverse scan control unit
231 Macroblock syntax decoding unit
232 NAL syntax decoding unit
233 Flag decoding unit 234 Quantized orthogonal transform coefficient decoding unit
241 Non-zero coefficient counter
242 Sort unit
243 Reverse scan order buffer
244 IDR decision unit
245 Flag decision unit
246 Reverse scan determination unit

1. An image processing apparatus comprising:
a scan order control unit which controls a scan order for transforming coefficient data transformed from an image to be coded from a two-dimensional array into a one-dimensional array, according to a statistical value indicating a feature of the image;
a scan unit which scans the coefficient data in the two-dimensional array according to the scan order controlled by the scan order control unit, and rearranges the coefficient data in the one-dimensional array; and
a coding unit which codes the coefficient data rearranged in the one-dimensional array by the scan unit.

2. The image processing apparatus according to claim 1, wherein the scan order control unit comprises:
a calculation unit which calculates an appearance frequency of a non-zero coefficient of the coefficient data per pixel position in a partial area of the image which is a processing unit of transform processing of transforming the image and generating the coefficient data and in a predetermined data unit; and
an update unit which updates the scan order in order of the appearance frequency of the non-zero coefficient of each pixel position in the partial area calculated by the calculation unit, and
the scan unit scans the coefficient data according to the scan order updated by the update unit.

3. The image processing apparatus according to claim 2, wherein the scan order control unit further comprises a determination unit which determines, as the scan order, one of an initial order which is a predetermined scan order set in advance and an update order which is the scan order updated by the update unit, and
the scan unit scans the coefficient data according to the scan order determined by the determination unit from the initial order and the update order.

4. The image processing apparatus according to claim 3, wherein the scan order control unit further comprises a decision unit which decides whether or not a processing target is an IDR picture, and
the determination unit determines the initial order as the scan order when the decision unit decides that the processing target is the IDR picture, and determines the update order as the scan order when the decision unit decides that the processing target is not the IDR picture.

5. The image processing apparatus according to claim 3, wherein the scan order control unit further comprises a detection unit which detects a scene change, and
the determination unit determines the initial order as the scan order when the detection unit detects the scene change in the processing target, and determines the update order as the scan order when the detection unit does not detect the scene change in the processing target.

6. The image processing apparatus according to claim 3, wherein the scan order control unit further comprises a generation unit which generates flag information indicating whether the determination unit determines the initial order as the scan order or selects the update order, and
the coding unit further codes the flag information generated by the generation unit.

7. The image processing apparatus according to claim 3, wherein the update unit updates the scan order to an order matching an order of the appearance frequency of the non-zero coefficient of each pixel position in the partial area of an image coded in a past.

8. The image processing apparatus according to claim 3, wherein, when a single picture is divided into a plurality of slices and processed, the update unit updates the scan order according to the order of the appearance frequency of the non-zero coefficient of each pixel position in the partial area of a slice coded immediately before.

9. The image processing apparatus according to claim 3, wherein, when a single picture is divided into a plurality of slices and processed, the update unit updates the scan order according to an order of the appearance frequency of the non-zero coefficient of each pixel position in the partial area of a slice at the same position as a current slice of a picture coded immediately before.

10. The image processing apparatus according to claim 3, wherein, when a single picture is divided into a plurality of slices and each slice is processed in parallel, the update unit updates the scan order according to an order of the appearance frequency of the non-zero coefficient of each pixel position in the partial area of a slice at the same position as a current slice of a picture coded immediately before.

11. The image processing apparatus according to claim 3, wherein the update unit updates the scan order to an order matching an order of the appearance frequency of the non-zero coefficient of each pixel position in the partial area of a current image to be coded.

12. The image processing apparatus according to claim 1, wherein the scan control unit controls the scan order per size of a partial area of the image which is a processing unit of transform processing of transforming the image and generating the coefficient data.

13. The image processing apparatus according to claim 1, wherein the scan control unit controls the scan order per type of a current image.

14. An image processing method of an image processing apparatus, comprising:
at a scan order control unit, controlling a scan order for transforming coefficient data transformed from an image to be coded from a two-dimensional array into a one-dimensional array, according to a statistical value indicating a feature of the image;
at a scan unit, scanning the coefficient data in the two-dimensional array according to the scan order, and rearranging the coefficient data in the one-dimensional array; and
at a coding unit, coding the coefficient data rearranged in the one-dimensional array.

15. An image processing apparatus comprising:
a decoding unit which decodes coded data of an image generated by controlling a scan order for transforming coefficient data transformed from the image to be coded from a two-dimensional array into a one-dimensional array according to a statistical value indicating a feature of the image;
a reverse scan order control unit which controls a reverse scan order for transforming the coefficient data obtained by decoding the coded data in the decoding unit, from the one-dimensional array into the two-dimensional array according to the statistical value indicating the feature of the image; and
a reverse scan unit which reversely scans the coefficient data in the one-dimensional array according to the reverse scan order controlled by the reverse scan order control unit, and rearranges the coefficient data in the two-dimensional array.

16. The image processing apparatus according to claim 15, wherein the reverse scan order control unit comprises:
a calculation unit which calculates an appearance frequency of a non-zero coefficient of the coefficient data per pixel position in a partial area of the image which is a processing unit of transform processing of transforming the image and generating the coefficient data and in a predetermined data unit; and
an update unit which updates the reverse scan order in order of the appearance frequency of the non-zero coefficient of each pixel position in the partial area calculated by the calculation unit, and
the reverse scan unit reversely scans the coefficient data according to the reverse scan order updated by the update unit.

17. The image processing apparatus according to claim 16, wherein the reverse scan order control unit further comprises a determination unit which determines, as the reverse scan order, one of an initial order which is a predetermined reverse scan order set in advance and an update order which is the reverse scan order updated by the update unit, and
the reverse scan unit reversely scans the coefficient data according to the reverse scan order determined by the determination unit from the initial order and the update order.

18. The image processing apparatus according to claim 17, wherein the reverse scan order control unit further comprises an IDR decision unit which decides whether or not a processing target is an IDR picture, and
the determination unit determines the initial order as the reverse scan order when the IDR decision unit decides that the processing target is the IDR picture, and determines the update order as the reverse scan order when the decision unit decides that the processing target is not the IDR picture.

19. The image processing apparatus according to claim 17, wherein the reverse scan order control unit further comprises a flag decision unit which decides a value of flag information indicating whether a scan order of the coefficient data is the initial order or the update order, and
the determination unit determines the initial order as the reverse scan order when the flag decision unit decides that the scan order of the coefficient data is the initial order, and determines the update order as the reverse scan order when the flag decision unit decides that the scan order of the coefficient data is the update order.

20. An image processing method of an image processing apparatus, comprising:
at a decoding unit, decoding coded data of an image generated by controlling a scan order for transforming coefficient data transformed from the image to be coded from a two-dimensional array into a one-dimensional array according to a statistical value indicating a feature of the image;
at a reverse scan order control unit, controlling a reverse scan order for transforming the coefficient data obtained by decoding the coded data, from the one-dimensional array into the two-dimensional array according to the statistical value indicating the feature of the image; and
at a reverse scan unit, reversely scanning the coefficient data in the one-dimensional array according to the reverse scan order, and rearranging the coefficient data in the two-dimensional array.
